(19) United States
(12) Patent Application Publication
(10) Pub. No.: US 2002/0016736 A1
(43) Pub. Date: Feb. 7, 2002

(54) System and method for determining suitable breaks for inserting content

(76) Inventors: George Dewey Cannon, Falls Church, VA (US); Kimble C. Cannon, McLean, VA (US); William Tracy, Falls Church, VA (US)

Correspondence Address: Pennie & Edmonds, LLP, 3300 Hillview Avenue, Palo Alto, CA, 94304, US

(21) Appl. No.: 09/844,523

(22) Filed: Apr. 27, 2001

Related U.S. Application Data
(63) Continuation-in-part of application No. 09/780,785, filed on Feb. 9, 2001.
Application No. 09/780,785 is a continuation-in-part of application No. 09/564,066, filed on May 3, 2000.

(51) Int. Cl. G06F 17/60

(52) U.S. Cl. 705/14

(57) ABSTRACT

The invention includes a method, apparatus, and computer program product for determining when to insert supplemental content between requested content, such as when to insert advertisements between requested Web-pages. In a preferred embodiment, a first request is intercepted from a user for first content. Subsequently, a second request is captured from the user for second content. It is then determined that the second request is independent of the first content. Finally, the insertion of supplemental content is facilitated, between the first content and the second content.

This application is a continuation-in-part of application Ser. No. 09/780,785 filed Feb. 9, 2001, entitled “System and Method for Controlling the Frequency of Advertisements Displayed During Media Presentations”, which is a continuation-in-part of application Ser. No. 09/564,066 filed on May 3, 2000, entitled “System and Method for Controlling the Frequency of Displayed Advertisements”.

### TECHNICAL FIELD

The present invention relates generally to advertising, and in particular to a system and method of controlling delivery of advertisements to consumers and for determining when to insert advertisements between requested content.

### BACKGROUND OF THE INVENTION

Advertising includes all forms of paid communication and promotion of products, services, or ideas by a specified sponsor. Advertising typically appears in print media, such as newspapers, magazines, billboards, and flyers, or broadcast media, such as radio and television. Print advertisements typically consist of a picture, a headline, and information about the product; whereas, broadcast advertisements typically consist of an audio/video narrative about a service or product.

With the growth of the Internet, conducting business on-line has become commonplace. As a place for direct retail shopping, with its 24-hour availability, global reach, ability to interact and provide custom information and ordering, and multimedia prospects, the Internet is rapidly becoming a multibillion dollar source of revenue for world businesses. The Internet is also quickly becoming one of the most effective ways for businesses to advertise their products and services to potential customers worldwide.

Internet advertising began in the early nineties, when the first advertisements were sold and the first commercially available Web browsers were released. By the late nineties, Internet advertising revenue generated approximately $2 billion a year (according to Internet World®). Assuming advertising revenue growth increases at the same rate, total advertising revenues could reach as much as $8 billion by 2002.

Internet advertising currently consists of banner advertisements, meta advertisements, rich media advertisements, interstitial advertisements, and the like. Banner advertisements, which consist of a graphic image file that is displayed along the width of the Web-page being viewed, are the most widely used type of advertisement on the Internet. Banner advertisements typically appear at the top or bottom of a Web-page, and appear in conjunction with the requested Web-site. Banner advertisements, however, have only enjoyed limited success in attracting users' attention as they are often not targeted to a particular user's attention and/or are ignored by the user who directs attention solely to the content of the requested Web-site.

Meta advertisements work in conjunction with search engines, and display a banner advertisement specific to a term searched on a search engine's search results page. This type of Internet advertisement is also referred to as keyword advertising. Advertisers pay search engines to target their advertisements, and to display their banner advertisements only when a user searches relevant keywords. Keyword advertising enables advertisers to target specific audiences. Again, however, because these advertisements appear in conjunction with the content of the requested Web-page, users often ignore them.

Rich media advertisements go beyond the mere display of a graphic image file, and may feature animation, sound, video, a small game, or the like. Rich media advertisements are basically small computer programs written in languages such as Java®, Java script®, or Virtual Reality Modeling Language (VRML). Although these types of advertisements are bandwidth intensive, they are slowly becoming more popular as Internet bandwidth increases for the average consumer, such as through the use of DSL (Digital Subscriber Line) or cable modems.

Interstitial advertisements typically take one of two forms, the pop-up interstitial or the inline interstitial. The pop-up interstitial, which is the most popular form of interstitial, is a temporary window that appears while the user waits for the principal destination page to load into memory. It is most often activated when a person first arrives at a Web-site. A small window pops up, advertising a product or service, while the principal destination page loads in the background.

In contrast, inline interstitial applications are fall-screen advertisements that appear in the user's browser window when the user navigates from one Web-page to another. Currently, it is only practical to display inline interstitial applications that are launched from a particular Web-page, and that appear either immediately before or after that Web-page is displayed. Thus, The instant patent makes it possible to also insert inline interstitial applications in a way that is like television commercials, in which the inline interstitial advertisements are viewed in-between the display of requested content. While the user is viewing the online interstitial advertisement in his browser window, the requested Web-page downloads in the background. Unlike banner advertisements, viewers of interstitial advertisements are more likely to give their full attention to both the advertisement and, in turn, the content the viewer requested.

Interstitial advertisements generally employ technologies such as Shockwave, Java®, or VRML. These technologies allow for the use of memory intensive content such as images and streaming audio or video presentations. As a result, such files often require a considerable time to download. Fortunately, most of these advertisement types provide a method to display requested Web-pages or images and sounds while loading the principal advertisement file into memory. During the preload of the larger files, smaller applets or movies keep the user's attention.

Interstitials are also referred to as splash screens, pop-up windows, parent windows, daughter windows, intermercials, extramercials, transitionals, superstitials® and child windows.

A survey by Jupiter Communications® predicts that 5 to 10 second animated interstitials will become common fare on the Internet by the early part of this century. Another study by MBInteractive® found that interstitials are significantly more effective than banner advertisements at creating a lasting impression in the minds of viewers.

A problem with Internet advertising, and interstitial advertisements in particular, is that the medium is, by its nature, obtrusive, as well as intrusive. A number of companies, such as Infoseek®, have implemented interstitial advertisements in the past, but in each case these companies have subsequently abandoned their use of these advertisements after their users complained that the advertisements were obtrusive to Internet navigation.

Furthermore, interstitial advertisements in which the user clicks a banner advertisement and a pop-up interstitial advertisement appears are the type of interstitial advertisement most favored by users because they put the user in partial control of the frequency of advertisements, as well as the opening and closure of the advertisements. In order to give users greater control over when they view advertisements, advertisers have proposed having the pop-up interstitial advertisements close automatically after a period of time and/or giving users greater control over the closing of the interstitial advertisement. Neither of these proposals, however, has been successfully implemented. A means for turning over control of the frequency of displaying interstitial advertisements to users would therefore be highly desirable.

A recent addition to the Internet advertising world is the introduction of advertiser sponsored personal computers and/or Internet access.

The companies that offer advertiser sponsored computers generally require the user of the computer either to sign-up, at a cost, with an affiliated Internet Service Provider (ISP) for a substantial period of time or to agree to the continual display of advertisements on a portion of the user's computer display screen.

The ISP market has seen a number of new entrants offering free Internet access, such as Spinway.com®. Virtually all of these free ISPs depend on revenue from advertising to subsidize the cost of the ISP services they provide. Most display this advertising in a browser embedded “advertising portal.” This advertising portal is essentially a banner advertisement that the user can move around his desktop, but that the user cannot remove or reduce in size. Recently, the number of people using these free ISP services has risen dramatically, and current market forecasts predict that this number will continue to rise. In 1999, 1.5 million American households accessed the Web through free ISPs. By 2003, more than 13 million households are expected to use some kind of free service to access the Internet. Of that group, 8.8 million U.S. Households are expected to use a free ISP as their primary access to the Internet (Source: Business Wire®, Dec. 6, 1999, citing study by Jupiter Communications, Inc.).

Typically, these advertiser sponsored free ISPs use proprietary software to display advertisements and customized content on a user's computer display (while the user is connected to the Internet via the sponsored ISP). The proprietary software serves as the advertisement delivery mechanism. In addition, some services require the user periodically to click on an advertisement and visit that advertiser's Web-site (click through) in order to stay connected to the Internet.

Neither the advertiser sponsored personal computer product nor the advertiser sponsored Internet access service allows users to control their exposure to the advertisements. It would therefore be highly desirable to provide a means for sponsoring a product or service paid for by a user's exposure to advertising, while allowing users to retain control of the frequency of their exposure to ads, especially if combined with the latest and most effective advertisement types, such as interstitial advertisements.

Furthermore, by augmenting an ordinary television set with an electronic set-top box, consumers are able to enroll in a service that will allow them to view specific content for a fee. The most common term for this practice is “pay-per-view.” The fee can be billed to the consumer's account, or it can be paid by credit card, either automatically or by phone. Recently, MICROSOFT™ released its DIGITAL BROADCAST MANAGER™ then allows e-commerce sites to offer pay-per-view video and audio broadcasts over the Internet. REALNETWORKS™ offers e-commerce sites the opportunity to outsource a similar service. No current service, however, gives consumers the option of receiving discounted video or audio (hereafter “media”) broadcasts in exchange for viewing advertisements. Therefore, a system that gives consumers the option of receiving discounted media broadcasts in exchange for viewing advertisements would be highly desirable.

### SUMMARY OF THE INVENTION

According to the invention there is provided a computer implemented method for determining when to insert supplemental content between requested content. A first request is intercepted from a user for first content. Subsequently, a second request is captured from the user for second content. It is then determined that the second request is independent of the first content. Finally, the insertion of supplemental content is facilitated, between the first content and the second content.

Further according to the invention there is provided an apparatus for determining when to insert supplemental content between requested content. The apparatus includes a bus, a central processing unit electrically coupled to the bus, a communications interface circuit electrically coupled to the bus and capable of electrically coupling to an electronic network, and a memory electrically coupled to the bus. The memory comprises instructions for intercepting a first request from a user for first content, and instructions for capturing a second request from the user for second content. The memory also comprises instructions for determining that the second request did not originate from the first content, and instructions for facilitating the insertion of supplemental content between the first content and the second content.

Still further according to the invention there is provided a computer program product for use in conjunction with a computer system. The computer program product comprises a computer readable storage medium and a computer program mechanism embedded therein. The computer program mechanism comprises instructions for intercepting a first request from a user for first content and instructions for capturing a second request from the user for second content. The computer program mechanism also comprises instructions for determining that the second request did not originate from the first content, and instructions for facilitating the insertion of supplemental content between the first content and the second content.

### BRIEF DESCRIPTION OF THE DRAWINGS

For a better understanding of the nature and objects of the invention, reference should be made to the following detailed description, taken in conjunction with the accompanying drawings, in which:

FIG. 1 is an electronic advertising network for controlling delivery of advertisements to users over the Internet and for adjusting the frequency of displaying the advertisements to the users;

FIG. 2 is a flow chart of a method of controlling delivery of advertisements to users over the Internet and for adjusting the frequency of displaying the advertisements to the users;

FIG. 3 is a continuation of the flow chart of FIG. 2;

FIG. 4 is a continuation of the flow chart of FIG. 3;

FIG. 5 is a continuation of the flow chart of FIG. 3, according to an embodiment of the Invention;

FIG. 6 is a continuation of the flow chart of FIG. 3, according to another embodiment of the Invention;

FIG. 7 is a continuation of the flow chart of FIG. 3, according to yet another embodiment of the Invention;

FIG. 8 is a graphical user interface of a frequency control page;

FIG. 9 is a diagrammatic view of a system topography according to a further embodiment of the invention;

FIG. 10A illustrates a diagrammatic view of a client computer shown in FIG. 9;

FIG. 10B illustrates a diagrammatic view of an intermediary server shown in FIG. 9;

FIG. 11 is a flow chart of a method for determining the frequency of advertisements displayed during media presentations;

FIG. 12 is a flow chart of a process for inserting advertisements into a media presentation at an intermediary server, according to yet another embodiment of the invention;

FIG. 13, which is a diagrammatic view of a process for inserting advertisements into media at an intermediary server, according to the embodiment of the invention shown in FIG. 12;

FIG. 14 is a flow chart of a process for inserting advertisements into a media presentation at a client computer, according to one other embodiment of the invention;

FIG. 15, which is a diagrammatic view of a process for inserting advertisements into media at an intermediary server, according to the embodiment of the invention shown in FIG. 14;

FIG. 16A is a diagrammatic view of a system for determining where to insert supplemental content between requested content according to an embodiment of the invention;

FIG. 16B is a diagrammatic view of another system for determining where to insert supplemental content between requested content according to another embodiment of the invention;

FIG. 17A is a flow chart of a method for determining where to insert supplemental content between requested content according to an embodiment of the invention;

FIG. 17B is a continuation of the flow chart shown in FIG. 17A; and

FIG. 17C is a more detailed flow chart of the determining step shown in FIG. 17A.

Like reference numerals refer to corresponding parts throughout the several views of the drawings.

### DETAILED DESCRIPTION OF THE INVENTION

The present invention allows users of advertiser sponsored computers or ISPs to choose the frequency with which advertisements are displayed on their computers. This choice will most often take the form of a selection from a continuum of ordinal frequencies (for example, selecting a point on a continuum between “a lot of advertisements” and “no advertisements”). However, in some instantiations, users may select a cardinal frequency (such as “1 advertisement per 100 URLs visited”). While these advertisements are preferably rich media interstitial advertisements, featuring animation and/or multimedia content, these advertisements may take any form and may include any type of content, including information not intended to induce a sale.

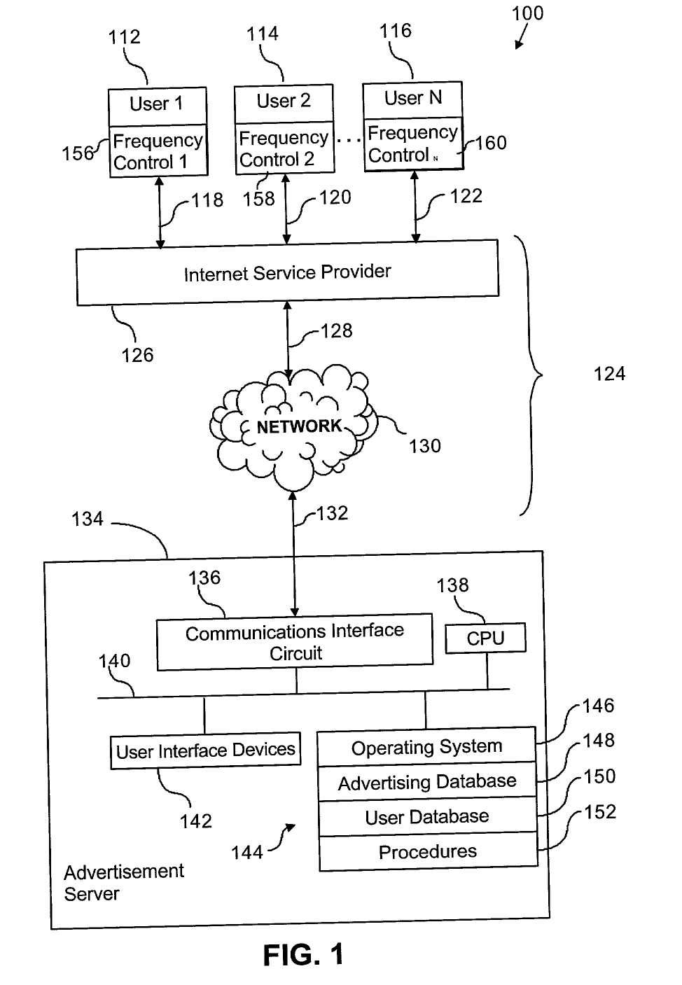

FIG. 1 is an electronic advertising network 100 for controlling delivery of advertisements to consumers or users over the Internet and for adjusting the frequency of displaying the advertisements to the users. More specifically, the electronic advertising network 100 includes users 112, 114, and 116, who, in turn, individually select a desired frequency at which the system will display advertisements on their computer displays. The system rewards users for displaying and viewing the ads, such that, the more advertisements a user views, the higher the reward. The reward may include free or subsidized use of a computer or computer program, such as a word processing application or game, access to further functions or levels within a computer program, a monetary reward or payment, frequent flier/user miles/points that the user can accumulate and redeem for goods or services, or free or subsidized use of a service, such as Internet access.

In one embodiment the user chooses how frequently he will be exposed to advertisements during a given Internet session and the ISP adjusts the monetary cost of Internet access for that user session accordingly.

In the preferred embodiment, the selected frequency is an approximate frequency. Thus, should a user be allowed to select a cardinal frequency (for example, once every 50 URLs), an advertisement will not necessarily be displayed at the 50th URL, as requested, but rather at a time after approximately 50 URLs in accordance with a set of rules, some of which are set out below.

In another embodiment, the user can select a higher frequency of advertisements in exchange for use of, and/or access to, additional functionality of a primary application. For example, if the primary application is a game, the user might choose to view additional advertisements in exchange for playing further levels of the game, playing for a longer period of time, or playing an increased number of individual plays.

According to the current practices in the software industry, software is often available for free, on a trial-period basis. This means that the software functions properly for some period (usually 30 days), and then is rendered unusable at the end of that trial period if there is no payment to the software vendor. The invention may be used to allow software vendors to provide trial usage of their software, not based on time usage, but rather on the amount of advertisements displayed on the user's computer.

In another embodiment, the invention may work in conjunction with the computer system itself, regulating the amount of advertisements displayed during any given usage session of the computer. Thus, a user may choose to have the system display no advertisements during a session in which the user is working on an important application, while the user may choose to have the system display advertisements more frequently during a session in which the user is using a less important application, such as a game.

Returning to FIG. 1, network 100 comprises a series of points or nodes interconnected by communication paths. The network may interconnect with other networks, may contain subnetworks and may be characterized in terms of its spatial distance as either a local area network (LAN), a metropolitan area network (MAN), a wide area network (WAN), or a global network (the Internet). The network may further be characterized by the type of service used, such as PSTN (Public switched telephone network), ISDN (Integrated Services Digital Network), DSL (Digital Subscriber Line), ATM (Asynchronous Transfer Mode), T-carrier system, etc. The network may also be characterized by the type of protocols used, such as TCP/IP (Transmission Control Protocol/Internet Protocol), NetBEUI (NetBIOS Extended User Interface), or IPX/SPX (Internetwork Packet Exchange/Sequenced Packet Exchange). Additionally, the network may be characterized by whether it carries voice, data, or both kinds of signals; by who can use the network (public or private); and by the usual nature of its connections (e.g. dial-up, dedicated, switched, non-switched, or virtual connections).

Network 100 connects a plurality of users 112, 114, and 116 to at least one advertisement server 134 via a communication network 124. Communication network 124 may comprise an Intranet or wireless communication network, but preferably comprises at least one Internet Service Provider (ISP) 126 and the Internet 130. Users 112, 114, and 116 connect to ISP 126 via communication links 118, 120, and 122. ISP 126, in turn, connects users 112, 114, and 116 to the Internet 130 via a communication link 128. In a similar manner, advertisement server 134 connects to the Internet 130 via a communication link 132. Communication links 118, 120, 122, 128, and 132 may, for example, be coaxial cable, copper wire (including PSTN), optical fiber, wireless, microwave, or satellite links.

It should be noted that although it is preferable that the advertisement server 134 be housed in a distinct location, the ISP 128 and the advertisement server 134 may be one and the same entity.

Advertisement server 134 comprises at least one data processor or central processing unit (CPU) 138, a memory 144, user interface devices 142, a communications interface circuit 136, and a bus 140 that interconnects these elements. The memory 144 includes an operating system 146, an advertisement database 148, a user database 150, and regulating procedures 152 that may include: instructions for storing advertisements in the advertisement database 148; instructions for determining a frequency for displaying said advertisements to users 112, 114, and 116; instructions for periodically transmitting selected advertisements from the advertisement database 148 to said users 112, 114, and 116; instructions for displaying the selected advertisements to users 112, 114, and 116 in accordance with said determined frequency; instructions for rewarding users 112, 114, and 116 for the amount of advertisements displayed; as well as other instructions. It should be noted that multiple servers or databases may also be used to store and execute the same procedures 152.

In addition, the operating system 146 may store instructions for communicating, processing data, accessing data, storing data, searching data, etc. The advertisement database 148 contains a plurality of advertisements, while the user database 150 contains a collection of user data organized into user profiles so that its contents can easily be accessed, managed, and updated. The databases 148 and 150 may, for example, comprise a relational database (a tabular database in which data is defined so that it can be reorganized and accessed in a number of different ways) or an object-oriented database (a database which is congruent with the data defined in object classes and subclasses). As mentioned above, the databases may be hosted on a single server or distributed over multiple servers.

Users 112, 114, and 116 use a remote client computer, typically a desktop computer, a handheld computer, personal digital assistant (PDA), or the like, to connect to the communications network 124 through communication links 118, 120, and 122. Users 112, 114, and 116 typically access the network in a usual manner, such as by using an Internet browser. Furthermore, the system may install proprietary software onto the users' remote client computers, including a frequency control device (multiple instances illustrated as 156, 158, and 160) that allows users to control the amount and frequency with which advertisements, are displayed on their remote client computer.

The frequency control device functions substantially independently of any outside system. The frequency control device may perform several functions, including: (i) launching a frequency control page, (ii) determining the frequency with which advertisements are displayed, based on a selection made by the user, (iii) logging advertisements which have already been displayed, (iv) displaying advertisements, (v) communicating with the advertisement server, (vi) saving a history of Uniform Resource Locators (URLs) requested by the user, where URLs are the addresses of files or resources accessible on the Internet, and/or (vii) monitoring the time a user spends online. The advertisement server may also perform any combination of the above functions such that, between the advertisement server and the frequency control device located on the remote computer, the invention is preferably capable of performing all of the required functions.

The frequency control device may be installed on the remote client computer in a number of ways. ISPs may distribute the frequency control device to their users by having the software pre-installed on the user's remote client computer by the computer's manufacturer, by allowing the users to download the software from a Web-page or File Transfer Protocol (FTP) host, or by mailing the software to the users on floppy disk, compact disk, or other transportable data storage medium. The frequency control device could also be delivered to remote computers without the involvement of an ISP.

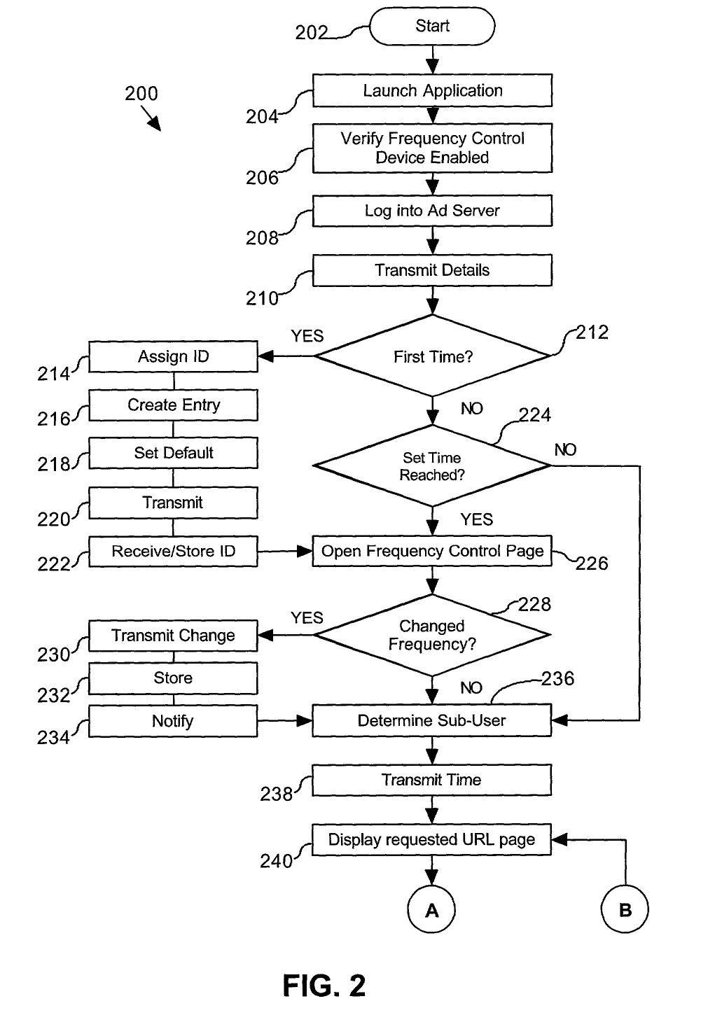

FIG. 2 is a flow chart of a method 200 of controlling delivery of advertisements to users over the Internet and for adjusting the frequency of displaying advertisements to the users. Here, the frequency control device communicates with the advertisement server, as described supra in relation to FIG. 1. The frequency control device can be installed onto a remote client computer together with ISP connection software, installed separately should the ISP connection software already be installed, or issued and installed independently of an ISP.

Users initiate the method 200 of controlling delivery of advertisements to users over the Internet at 202, by connecting to the ISP. The user then launches the frequency control device application or software at 204. The frequency control device may be incorporated into the user's Internet browser software or it may be executed separately when the user initiates his connection to the ISP. In either case, the frequency control device has access to all information transmitted between the remote client computer and the ISP.

In one embodiment, the frequency control device may run alongside or be incorporated into the Internet browser, such that it communicates the URLs requested by the Internet browser to the ISP (via the computer's modem or network interface card (NIC)). For example, if a user is using Microsoft's Internet Explorer® software to view Internet Web-pages, the path of data going to the Internet would be: Internet Explorer®→Winsock (TCP/IP module of Windows®)→(modem or NIC)→ISP Modem or Hub→Router→Internet. The frequency control device either replaces the Winsock on the User's remote client computer or preferably acts as an interface between Internet Explorer® and the Winsock. The frequency control device will, for the most part, behave exactly like the Winsock, passing URL requests from the Internet browser to the modem or NIC. The frequency control device, however, is augmented with the functionalities described supra.

It should be noted that the frequency with which the system displays advertisements to the user may be regulated by any party, but preferably by a user or Internet Service Provider (ISP) who does so using the frequency control device at the start of, or any time during, each usage session. The frequency control device could function either as a “child” application within another primary computer program or as a separate application operating simultaneously with another primary computer program. Furthermore, the system could launch the frequency control device at the same time as the user launches the primary application or the system could launch the frequency control device at the beginning of each computing session.

If the frequency control device is a separate program or plug-in from the ISP dial-up or networking software (the DUN software), the DUN software or the browser then verifies that the necessary frequency control device is enabled at 206. Once connected to the ISP, the frequency control device logs into the advertisement server at 208 and transmits details to the advertisement server at 210. These details may include a request for the first URL, the time of day, any applicable log-on, sub-user differentiation information, the remote client computer Internet Protocol (IP) address, the ISP's IP address, the identity of any advertisements currently stored on the user's computer, and/or a frequency control device identification (ID) code or number.

The ID code is a unique code or identification number which the system assigns to each copy of the frequency control device. A sub-user is a different user using the same remote client computer, for example different family members using the same computer. A separate profile or sub-user log is kept for each sub-user, and may contain a URL history, time of day history, and a probable-time-to-click-off-page-function for that sub-user (explained infra). The sub-user log is stored in the advertisement server database, 148 of FIG. 1.

The system may furthermore use a statistical and/or artificial intelligence methodology such as a Bayesian statistical network, to differentiate and identify different sub-users of a remote client computer. Such a methodology could, for example, use the time of day history, the selected advertisement frequency, and the first few URLs requested to identify which one of several different sub-users is accessing the Internet during a given session. This methodology would allow the system to target advertisements to specific sub-users who access the Internet through a common ISP account.

The system then determines at 212 whether this is the first time the frequency control device has transmitted data to the advertisement server. As discussed above, every copy of the frequency control device has an associated ID code which it uses to identify itself as the source of all information it sends to the advertisement server.

When a copy of the frequency control device contacts the advertisement server for the first time, it identifies itself to the advertisement server by sending a default frequency control device ID code. When the advertisement server receives this default ID code, it recognizes that it has come from a copy of the frequency control device that has never contacted the advertisement server before, and at 214 it assigns a new, uniquely identifiable, ID code to that copy of the frequency control device.

The advertisement server uses the new ID code (in conjunction with a code identifying the ISP through which the frequency control device transmitted the information) to create an entry for that user in the user database at 216. All fields in that user entry are set to predetermined defaults at 218. The entry fields may include: the “probable-time-to-click-off-page-function” (discussed below), user demographics, sub-user profiles, and desired advertisement frequency. The advertisement server transmits, at 220 this new ID code to the frequency control device, which receives and stores the new ID code at 222. The frequency control device then opens the frequency control page at 226.

If this is not the first time that the frequency control device has communicated with the advertisement server, then the system determines at 224 whether a set time for displaying a frequency control page has been reached. If the set time has not been reached, then the system determines at 236 which sub-user is accessing the system. If the set time for displaying the frequency control page, as set either by default or by the user, has been reached, the system will open the frequency control page at 226.

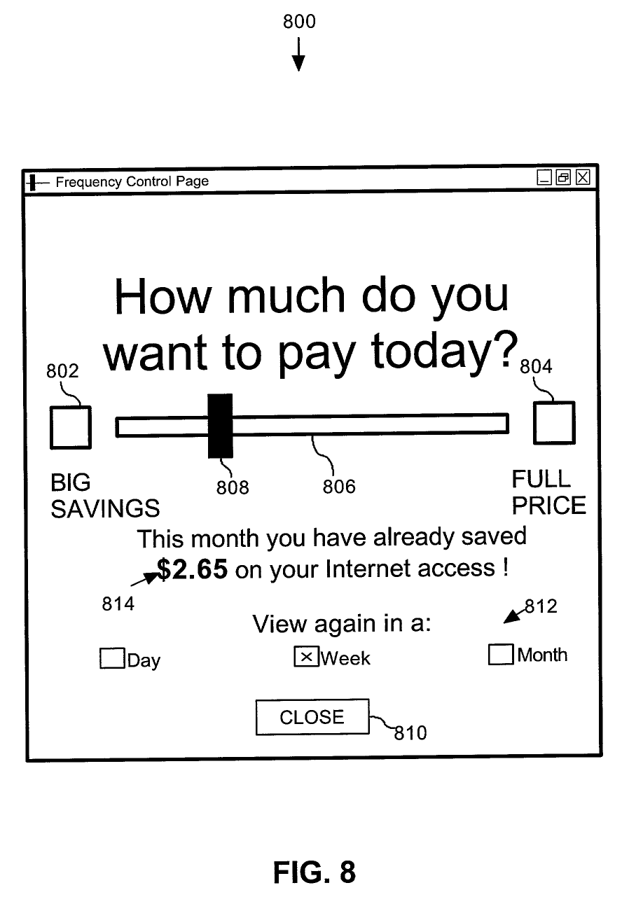

The frequency control page may open in a separate browser window which “pops-up” above the primary browser window. The frequency control page allows a user to select the frequency of advertisements displayed. FIG. 8 depicts an illustrative frequency control page 800 displayed by a graphical user interface (GUI). The user can move this page or window to the background or close it should he wish to do so. This frequency control page preferably contains HTML text and an embedded executable program, such as a Java® applet which communicates with the advertisement server. The user can adjust the frequency at which the system will display advertisements by making a selection using an interface.

This interface can take any of a number of forms, but is preferably a slider mechanism which allows the user to make a selection by either sliding or dragging a slider 808 along a bar 806. The bar represents a continuum between frequently viewing advertisements and viewing few or no advertisements. Additionally, the system may give the user the option of clicking on a box at either end of this continuum. These boxes might indicate “Big Savings” or “Maximum Savings” at one end of the continuum and “Full Price” or “No Savings” at the other end.”

The frequency control page may display a monetary amount 814 indicating how much money the user has saved by viewing advertisements. The frequency control page may also display a series of boxes 812 to allow the user to set the time when he would again like to view the frequency control page. The frequency at which the system displays advertisements and the time when the system will again present the frequency control page to the user are originally set to defaults. Thus, the frequency control page gives the user the option of selecting an advertisement frequency and/or a future time when the system will display the frequency control page, such as in a week or a month. Once the user selects these options, the frequency control page transmits this information from the frequency control page to the advertisement server. The frequency control page may also transmit this information to the frequency control device.

The frequency control device uses the client computer's internal clock to determine when the frequency control page must again be displayed. Unless the user otherwise requests to change the advertisement frequency (for example via an ISP's homepage), the advertisement frequency selected will be saved as the current advertisement frequency until the frequency control page is next displayed. Alternatively, if no default is set by the system, the user may not close the frequency control page by clicking on close button 810 until he selects the next time to view the control page using one of boxes 812. It should be noted that the frequency control page is only a preferred means of interfacing with the user, any other suitable means may also be used. In another embodiment, the ISP and not the user determines the frequency for displaying the ads.

If the user closes the frequency control page without moving the slider 808, or simply leaves the frequency control page in the background without moving the slider 808, the advertisement frequency will remain set to the original default or a previous value set by the user. Alternatively, the default may initially be set by the ISP.

Returning to FIG. 2, if the user changes the advertisement frequency, the new advertisement frequency is transmitted at 230 from the frequency control page to the advertisement server, which stores this information in the appropriate entry and field of the user database at 232. The frequency control page also notifies the frequency control device at 234 of the new frequency.

The system using statistical and/or artificial intelligence methodology such as Bayesian statistical logic (contained on the advertisement server) uses the time of day, the first URL requested, any log-on sub-user differentiation information, and the selected advertisement frequency to determine at 236 a first estimate of which sub-user is currently accessing the Internet. The sub-user may also be determined by using further information supplied by the ISP or the user himself.

The probable-time-to-click-off-page-function is a function that enables the frequency control device to determine the optimal time to initiate an incremental download of advertisements or other data from the advertisement server. For example, in a preferable embodiment, this function uses probability distribution functions based on the time the user previously spent on Web-pages. The system constructs probability distribution functions for each sub-user and uses these functions to determine the probability that a sub-user will remain on a given page long enough to allow the frequency control device to download an advertisement segment or other data from the advertisement server to the client computer. In this regard, the proposed function assumes that, if a user stays on a page for a certain amount of time, it is indicative that the user will in probability, remain on that page for an additional period of time. Thus, the probable-time-to-click-off-page-function determines the critical number of seconds a sub-user must spend on a page to allow the system to completely download an advertisement segment or data packet before the sub-user requests a new URL.

The advertisement server then transmits at 238 the probable-time-to-click-off-page-function associated with that sub-user to the frequency control device, and informs the frequency control device which sub-user log to use. In one embodiment of the invention, the advertisement server simultaneously transmits both the requested advertisement frequency and the probable-time-to-click-off-page-function to the frequency device. In another embodiment, however, the frequency control device records the requested advertisement frequency at the time it is transmitted from the frequency control page. If this is the first session during which the frequency control device has communicated with the advertisement server, the advertisement server will send the frequency control device a default probable-time-to-click-off-page-function, which the frequency control device uses until it is updated by the advertisement server.

At any prior time, but preferably when the frequency control device transmits details to the advertisement server at 210, the user may request a specific URL. The system then displays the requested URL Web-page at 240. In the unlikely event that the frequency control device does not receive a response from the advertisement server within a fixed period of time (say, 20 seconds), the first requested URL is displayed, regardless.

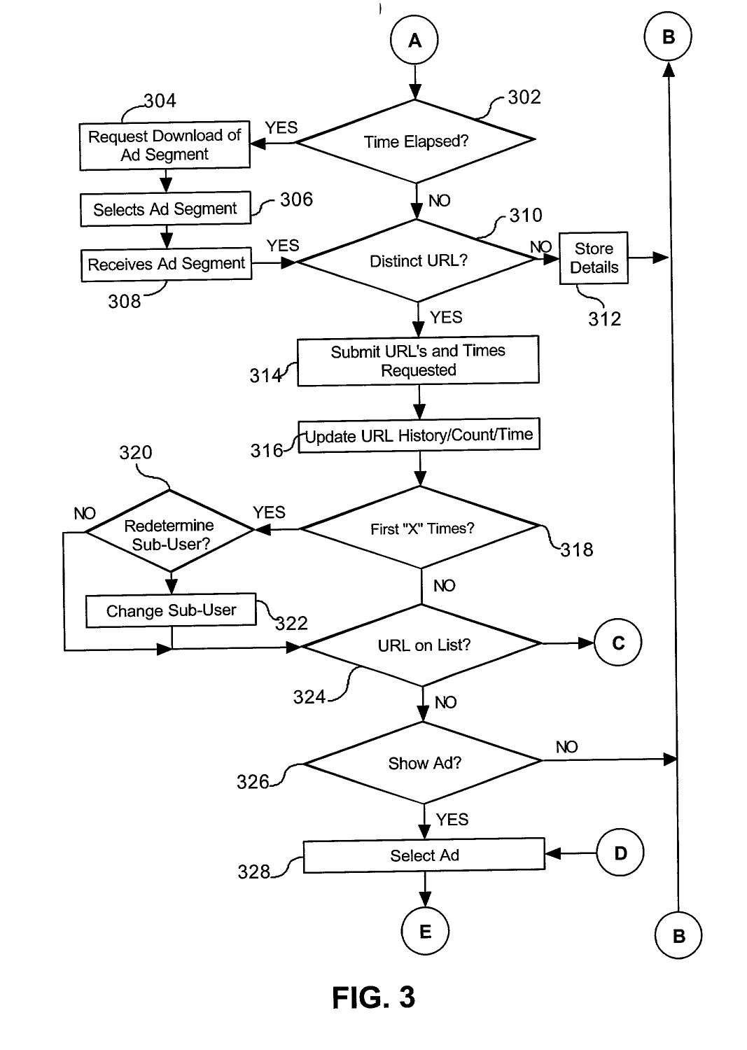

FIG. 3 is a continuation of the flow chart of FIG. 2. The system, using the probable-time-to-click-off-page-function, then determines at 302 whether the user has remained on a single Web-page longer than the time usually spent viewing a Web-page, i.e., whether the time has elapsed. The advertisement server uses a user's specific history of the time intervals between requested URLs to develop heuristic rules regarding the optimal time to incrementally download an advertisement segment. The frequency control device stores the rules, and periodically transmits them to the advertisement server. While the user is viewing a Web-page, the frequency control device continually compares the time the user spends on the Web-page to these rules.

If, according to the probable-time-to-click-off-page-function, the optimal time has elapsed, the frequency control device immediately requests the download of an advertisement segment or data packet at 304. The advertisements are preferably split into segments or packets for ease of download, but may alternatively utilize a burst, streamed, paced, or continuous operation. The advertisement server selects at 306 an advertisement segment or data packet to download based on variables, such as its estimation of which sub-user is accessing the system, a log of which advertisements it has already downloaded and/or displayed, and/or the URL history for this, and past, sessions. The advertisement server transmits the selected advertisement or data packet to the frequency control device, which then receives the downloaded advertisement, at 308.

If the user requests a URL before the probable-time-to-click-off-page-function determines that the probability of an advertisement segment or data packet being completely downloaded is high or before an advertisement segment or data packet completely downloads, the system ascertains whether a distinct URL has been requested at 310. A distinct URL is a new URL that is not merely another Web-page within the same Web-site (for example if the homepage is www.rapidtranslate.com and the user requests www.rapidtranslate.com/mem.html, the user has not requested a distinct URL). If the user does not request a distinct URL, the requested (non-distinct) URL and the time since the last URL request are stored on the frequency control device at 312; and the system displays the requested Web-page at 240.

In an alternative embodiment, before displaying an advertisement and instead of determining whether the requested URL is distinct, the system may ascertain whether the user either has spent a long time browsing one Web-site or has viewed a predetermined number of Web-pages within a single Web-site. If either determination is positive, the system proceeds in the same fashion as if the requested URL was found to be distinct.

If the user requests a distinct URL (for example the user is viewing www.rapidtranslate.com and then requests www.pennie.com), the frequency control device transmits at 314 the stored log of all URLs requested since the last upload to the advertisement server and the times at which the user requested each URL to the advertisement server. When the advertisement server receives the frequency control device's log of requested URLs and times, the advertisement server updates at 316 the count of pages requested and displayed since the last advertisement was viewed, the sub-user URL history, and sub-user time/per page data. The updated data is stored under the sub-user's profile in the user database on the advertisement server. This system uses this data to reevaluate the sub-user, recalculate the probable-time-to-click-off-page-function, and to target specific advertisements to the sub-user.

The advertisement server then increases, by one, a counter that is reset at the start of every session. Next, the advertisement server determines at 318 whether the value of that counter is less than or equal to some variable “X.” If the value is less than or equal to “X,” then the advertisement server considers the process to be within the first “X” iterations and the sub-user may be redetermined at 320. For example, only during the first 3 times that the system reaches this point in the process will the system attempt to redetermine the sub-user.

Thereafter, the system uses statistical and/or artificial intelligence methodology such as Bayesian statistical logic to determine at 320 whether the sub-user URL history and probable-time-to-click-off-page-function remain consistent with an unbiased estimate of which sub-user is currently accessing the Internet.

Specifically, the system's estimate of which sub-user is currently accessing the Internet will not be changed if the data acquired since the last time the system estimated the sub-user does not indicate that this user is another known sub-user. If the system redetermines the sub-user, the system changes at 322 which sub-user profile is correlated with the user currently accessing the system, instructs the frequency control device as to which sub-user log to use, and informs the frequency control device as to which probable-time-to-click-off-page-function to use.

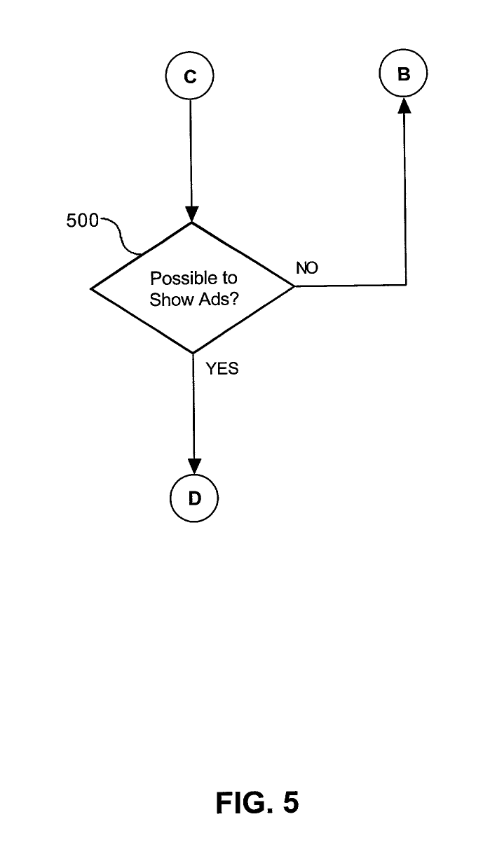

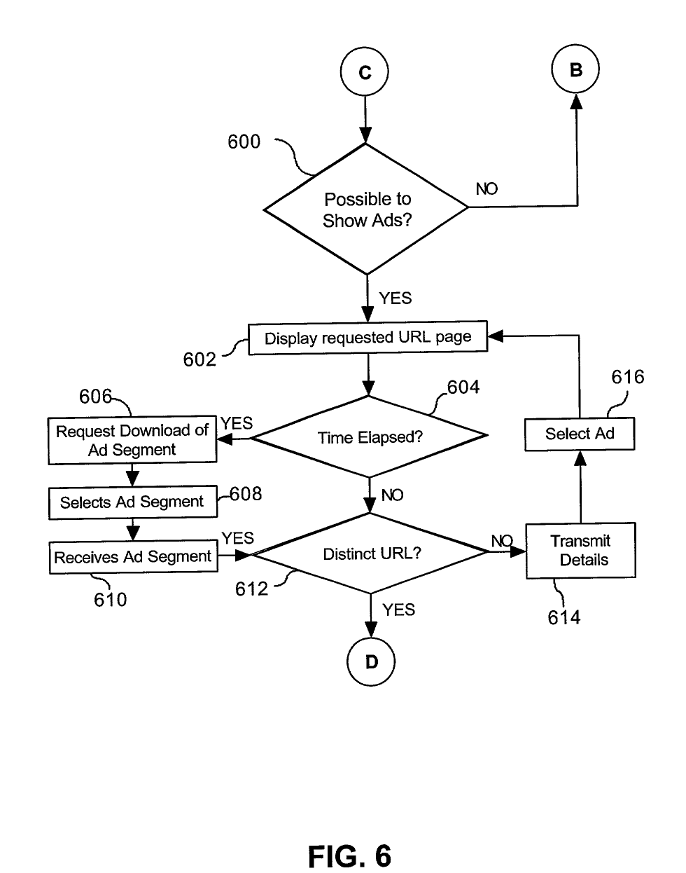

The system then compares the most recent distinct URL requested to a special instruction list (a list of URLs and a set of instructions associated with each of those URLs, e.g. a URL of a search engine might be on the special instruction list and subsequently have special instructions associated with it) at 324. FIG. 5 and FIG. 6 are examples of the processes that the system may undertake in accordance with the special instructions list.

As shown in FIG. 5, if the requested URL is on the list, the system determines whether to follow through with the special instructions or simply to display the requested Web-page at 500. To determine whether to follow through with the special instructions, the system uses variables, such as the advertisement frequency selected, the number of advertisements recently shown to this user, and a numeric value quantifying the value of showing an advertisement when a user views that page. If it is possible to display an advertisement, at 500 the system selects an advertisement at 328 of FIG. 3. If it is not possible to display an advertisement, at 500 the system displays the requested URL Web-page at 240 of FIG. 2.

Alternatively, as shown in FIG. 6, if the URL is on the special instructions list, the system determines at 600 whether to follow through with the special instructions or simply to display the requested page. To determine whether to follow through with the special instructions, the system uses the advertisement frequency selected, the number of advertisements recently shown to this user, and a numeric value quantifying the value of showing an advertisement to a user. For example, assume a user is in the process of making an on-line purchase. The value of showing an advertisement related to that purchase just before the user decides exactly what to buy (or where to buy it) is greater than the value of showing the same advertisement at any other time.

If it is not possible to display an advertisement, the requested URL is displayed at 240 of FIG. 2. If it is possible to display an advertisement the requested URL is displayed at 602. The system, using the probable-time-to-click-off-page-function, then determines at 604 whether the user has remained on a single Web-page for longer than the time usually spent viewing a Web-page, i.e., whether the time has elapsed, as described in relation to reference numeral 302.

If, according to the probable-time-to-click-off-page-function, the user has spent enough time on the page to indicate that the probability is high that an advertisement segment has been completely downloaded the frequency control device immediately requests the download of an advertisement segment or data packet at 606. The advertisements are preferably split into segments or packets for ease of download, but may alternatively utilize a burst, streamed, paced, or continuous operation. The advertisement server then selects at 608 an advertisement segment or data packet to download based on variables such as an estimation of which sub-user is accessing the system and/or a log of the advertisements which have already been downloaded and/or displayed. The advertisement server transmits the selected advertisement segment or data packet to the frequency control device, which receives the advertisement segment or data packet at 610.

If the user requests a URL before the frequency control device determines that there is a high probability that an advertisement segment or data packet will be completely downloaded (such determination is based on the probable-time-to-click-off-page-function) or before an advertisement segment or data packet completely downloads, the system ascertains at 612 whether the user has requested a distinct URL. If the user has not requested a distinct URL, the requested (non-distinct) URL and the time since the last URL request are transmitted to the advertisement server at 614. The advertisement server then selects an advertisement at 616 and the frequency control device then displays the requested Web-page at 602. Thereafter, the process is repeated until the user requests a distinct URL at 612.

An example of the process shown in FIG. 6 is where a user requests a web search page URL that is on the special instruction list, such as www.yahoo.com. The system displays the web search page URL at 602. If the user has remained on the Web-page for longer than the time set by the probable-time-to-click-off-page-function, the frequency control device requests that the advertisement server send an advertisement segment or data packet. The advertisement server then selects an advertisement segment or data packet, transmits it to the frequency control device, and the frequency control device receives and stores the selected advertisement at 604 to 610.

If the time has not elapsed or the advertisement has already been downloaded, the system then determines at 612 if a distinct URL is requested. Usually a non-distinct page will be requested as the search engine will display a “hits” page displaying a list of the sites found for the term(s) searched, such a list of sites dealing with searched terms—“new cars,” for example. The frequency control device then transmits this URL at 614 to the advertisement server, including the terms searched, such as “new cars” in the example. The system then selects at 616 an appropriate advertisement to display, such as an advertisement selling a new GM® car, and displays the “hits” page, at 602.

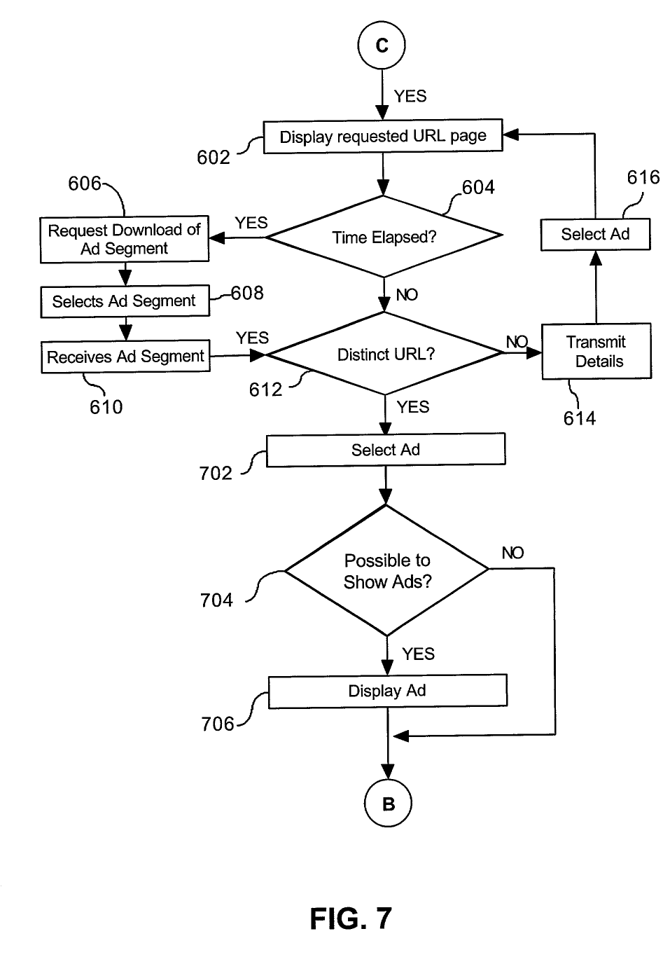

Once the user requests a distinct URL at 612, the system either selects an advertisement at 328 of FIG. 3 or displays the requested URL page at 702 of FIG. 7.

Alternatively, as shown in FIG. 7, once the system displays the requested URL page at 602, the process is similar to that described in relation to FIG. 6. However, once another distinct URL is requested at 612, the system selects an advertisement at 702 and the system determines at 704 whether the advertisement should be displayed. The decision whether to display an advertisement is based on variables such as the selected advertisement frequency, as determined by the user, the number of URLs uploaded, and other factors. If an advertisement is not to be displayed, the system displays the requested URL Web-page at 240 of FIG. 2. If the system determines at 704 that an advertisement should be displayed, the system displays the selected advertisement at 328 and then displays the requested URL Web-page at 240 of FIG. 2.

It should be noted that the embodiments described in relation to FIGS. 5 to 7 may operate independently, in the alternative, or, preferably, in combination, where different actions may occur depending on the URL requested.

Returning to FIG. 3, if the requested URL is not on the special instruction list, the system determines at 326 whether it should nevertheless display an advertisement. The decision of whether to display an advertisement is based on variables such as the selected advertisement frequency, as determined by the user, the number of URLs uploaded, and other factors. If the system determines that it should not display an advertisement, it displays the requested URL Web-page at 240 of FIG. 2. If the user has viewed a set number of Web-pages and the system has determined at 326 that an advertisement should be displayed, the system selects at 328 an advertisement to be displayed.

Alternatively, the system may display the Web-page for distinct URLs as soon as possible, regardless of whether the advertisement server has communicated with the frequency control device. In this embodiment, the frequency control device only delays (by waiting for a response from the advertisement server) the display of a requested distinct URL when: a) according to the selected advertisement frequency, it is almost time to display an advertisement or b) the advertisement server instructs the frequency control device to wait for instructions before displaying distinct URLs. Such instructions may be part of the instructions for URLs on the special instructions list.

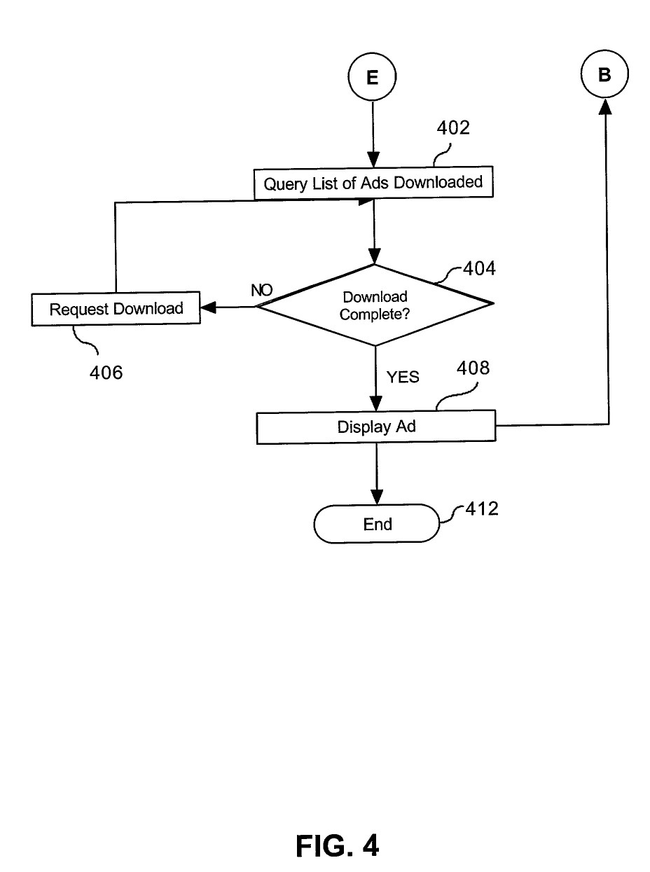

FIG. 4 is a continuation of the flow chart of FIG. 3. At 402 the system queries a list of which advertisements it has already downloaded to the user's remote client computer. This list may be stored on the advertisement server, on the remote client computer, or on both the advertisement server and the remote client computer. The system then determines whether the selected advertisement has been completely downloaded at 402. If the advertisement has not been completely downloaded, the advertisement server transmits the advertisement to the frequency control device at 406. Once the advertisement has been downloaded in its entirety, the system displays at 408 the advertisement to the user, preferably as an inline interstitial. The system then displays the next requested URL at 240 of FIG. 2.

Once the user terminates his Internet session at 412, the frequency control device closes. Whenever the user terminates his Internet session, a list of all URLs stored and the time the session terminated are sent to the advertisement server. There are numerous indicators as to when the user has terminated the Internet session, including, but not limited to, when the browser closes, after the system is idle for more than a certain amount of time, or when the user physically logs-off the system.

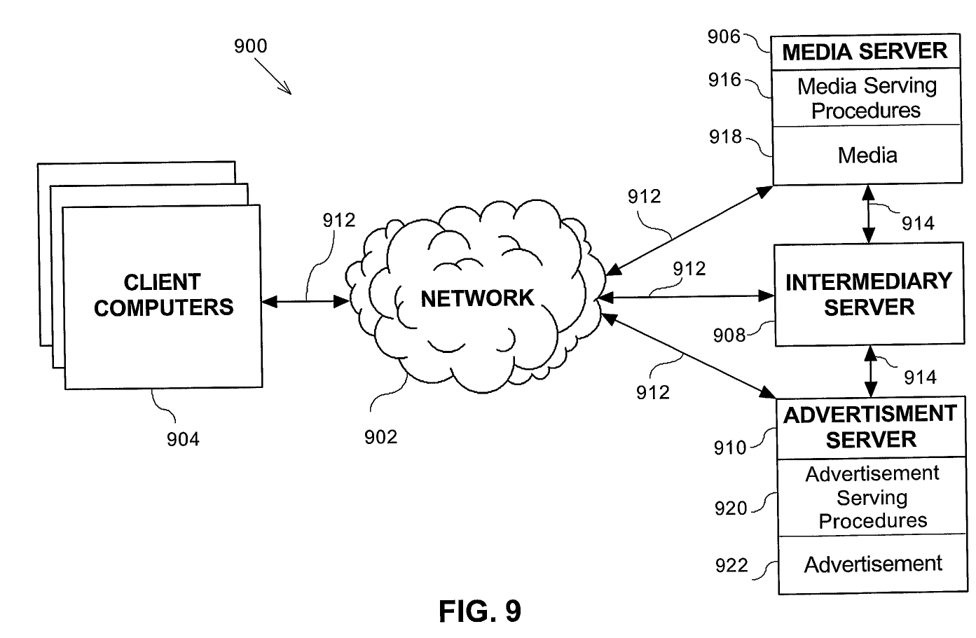

FIG. 9 is a diagrammatic view of a system topography 900 according to a further embodiment of the invention. The system topography 900 is used to distribute advertisements and other messages, preferably through downloadable or streaming media content, via an electronic network 902. This embodiment is used for media presentations, such as television broadcasts, satellite television transmissions, cable television transmissions, video on demand, such as unicast or multi-cast downloadable or streaming video via the Internet, and the like. These media presentations preferably use standard NTSC or PAL analog waveform, MPEG-2 or MPEG-4 format, REAL VIDEO format, streaming media format, or the like.

Currently, there are two primary ways to stream content via a network, unicast and multicast. Unicast and Multicast refer to all types of streaming media distributed over the Internet, including “video on demand.” Unicast communication refers to communication between a single sender and a single receiver over a network. Streaming unicast media requires each client computer to have a distinct connection with the host server (the server responsible for transmitting the streaming content). This is sometimes referred to as Point-to-Point transmission.

Multicast communication is communication between a single sender and multiple receivers on a network. Multicast is also used for programming on the Mbone, which is a system that allows users at high-bandwidth points on the Internet to receive live video and audio programming. In addition to using a specific high-bandwidth subset of the Internet, Mbone multicast also uses a protocol that allows signals to be encapsulated as a TCP/IP (Transmission Control Protocol/Internet Protocol) packet when passing through parts of the Internet that can not handle the multicast protocol directly. The channel bandwidth for MBone multicasts is 500 kilobits per second and actual traffic is from 100-300 kilobits depending on content. MBone multicasts usually consist of streaming audio and video.

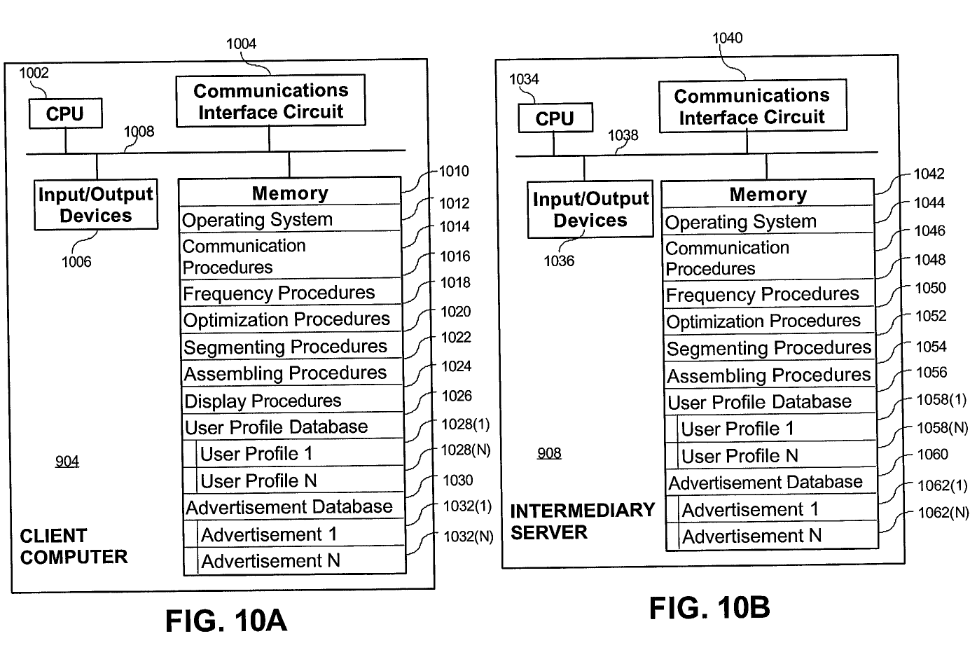

The embodiment of the invention shown in FIG. 9 allows for advertisements to be placed within a unicast or multicast streaming broadcast based on a client-selected frequency for displaying the advertisements during media presentations. Users, using client computers 904, connect to an electronic network 902 (hereafter “network”), via a communication link 912. The client computers 904 are preferably desktop computers, but alternatively may be set-top boxes, such as cable-boxes, pay-per-view boxes, WEB-TV® enabled televisions, pay-per-view enabled Satellite-TV systems, or any device capable of displaying content and advertisements and/or transmitting billing information. The client computers 904 may also be handheld computers, personal digital assistants (PDAs), cellular phones with Internet service, such as WAP (Wireless Application Protocol) or i-Mode, or the like. The client computers 904 are explained in further detail in relation to FIG. 10A below.

The network 902 comprises a series of points or nodes interconnected by communication paths. The network 902 may interconnect with other networks, contain subnetworks, and may be embodied by way of a local area network (LAN), a metropolitan area network (MAN), a wide area network (WAN), an Intranet, a cable or satellite TV network, or preferably a global network, such as the Internet. The network 902 may further be characterized by the type of access service used, such as PSTN (Public Switched Telephone Network), ISDN (Integrated Services Digital Network), DSL (Digital Subscriber Line), ATM (Asynchronous Transfer Mode), T-carrier system, etc.

In addition, the network 902 may be characterized by the type of technologies used on it, such as TCP/IP (Transmission Control Protocol/Internet Protocol), WAP (Wireless Application Protocol), CDMA (Code-division Multiple Access), NetBEUI (NetBIOS Extended User Interface), or IPX/SPX (Internetwork Packet Exchange/Sequenced Packet Exchange). Additionally, the network 902 may be characterized by who can use the network (whether it is public or private); and by the usual nature of its connections (e.g., dial-up, dedicated, switched, non-switched, or virtual connections).

A media server 906, an intermediary server 908, and an advertisement server 910 also connect to the network 902, via communication links 912. The media server 906 and advertisement server 910 preferably also connect to the intermediary server 908, via communication links 914. Communication links 914 preferably connect via the network 902, but alternatively may connect via connections distinct from the network 902. Communication links 912 and 914 may be any suitable communication links, such as coaxial cable, copper wire, optical fiber, wireless, microwave, fixed wireless, or satellite links, employing any or all of the access services and protocols set forth above.

The media server 906 and advertisement server 910 are preferably standard computer servers having at least one data processor or central processing unit (CPU); input/output devices; a communication interface circuit; and at least one bus that interconnects these components. The media server 906 also preferably includes a memory containing media serving procedures 916 for serving media 918. Media as used herein is any element through which a message is communicated, but preferably contains a multimedia presentation combining text, audio, and/or motion video. Likewise, the advertisement server 910 also includes a memory containing advertisement serving procedures 920 for serving advertisements 922. Advertisements as used herein are any notices or announcements, preferably selling a product or service, and preferably in electronic multimedia form. It should be noted that the intermediary server 908, media server 906, and the advertisement server 910, may be distinct servers, the same server, or a combination of servers.

FIG. 10A illustrates a diagrammatic view of a client computer 904 shown in FIG. 9. The client computer 904 preferably includes at least one data processor or CPU 1002; a communication interface circuit 1004 for communicating with the network 902 (FIG. 9); input/output devices 1006, such as a keyboard and monitor; a memory 1010; and at least one bus 1008 that interconnects these components.

Memory 1010 preferably includes an operating system 1012 (such as SOLARIS®, WINDOWS NT®, LINUX®, MACOS®, Phone.com's operating system, and Palm OS) that stores instructions for communicating, processing, accessing, storing, or searching data, etc. Memory 1010 also preferably includes communication procedures 1014; optimization procedures 1018; segmenting procedures 1020; assembling procedures 1022; display procedures 1024; a user profile database 1026; an advertisement database 1030; and preferably a frequency procedures 1016.

The communication procedures 1014 are used for communicating between the client computer and the network. In one embodiment of the invention, frequency procedures 1016 stored in the memory 1018 are used for determining the frequency that advertisements are to be displayed on the client computer. The optimization procedures 1018 are used for optimizing the advertisements displayed on the client computer.

The segmenting procedures 1020 are used for cutting or editing the media into parts which are later assembled together with the advertisements by the assembling procedures 1022. The display procedures 1024 control the display of the media and advertisements on the output devices. The user profile database 1026 preferably contains user profiles 1028 for a number of users of the client computer. Finally, the advertisement database 1030 contains multiple advertisements 1032.

FIG. 10B illustrates a diagrammatic view of the intermediary Server 908 shown in FIG. 9. The intermediary Server 908 preferably includes at least one data processor or CPU 1034; a communication interface circuit 1040 for communicating with the network 902 (FIG. 9); input/output devices 1036; a memory 1042; and at least one bus 1038 that interconnects these components.

Memory 1042 preferably includes an operating system 1044 (such as SOLARIS®, WINDOWS NT®, LINUX®, or MACOS®), that stores instructions for communicating, processing, accessing, storing, or searching data, etc. Memory 1042 also preferably includes communication procedures 1046; frequency procedures 1048; optimization procedures 1050; segmenting procedures 1052; assembling procedures 1054; a user profile database 1056; and an advertisement database 1060.

The communication procedures 1046 are used for communicating between the intermediary Server 908 and the network. The frequency procedures 1048 are used for determining the frequency that advertisements are to be displayed on the client computer. The optimization procedures 1050 are used for optimizing the advertisements displayed on the client computer.

The segmenting procedures 1052 are used for cuffing or editing the media into parts which are later assembled together with the advertisements by the assembling procedures 1054. The user profile database 1056 preferably contains user profiles 1058 for a number of users of the client computer. Finally, the advertisement database 1060 contains multiple advertisements 1062.

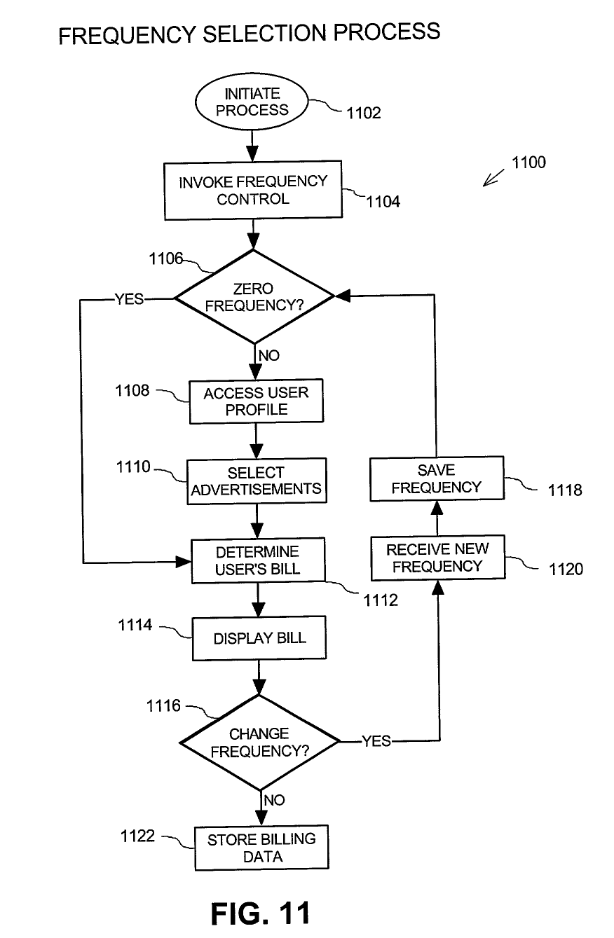

FIG. 11 is a flow chart of a method 1100 for determining the frequency of advertisements displayed during media presentations. A user of the client computer 904 (FIG. 9) initiates at 1102 the process through which he or she will purchase content on a pay-per-view basis. The process can be initiated either before or after the media is requested.

A frequency control page or graphical user interface (GUI), such as that shown in FIG. 8, is then invoked at 1104. Should the client computer be a set-top box, the frequency control page may be designed for easier control with a infrared remote device, such as by using the increase and decrease volume keys on the remote device instead of a mouse.

The frequency control page is preferably stored on the client computer in the user profile 1028 (FIG. 10), but may alternatively be stored on the intermediary server in the user profile 1058 (FIG. 10B).

The frequency procedures 1016 (FIG. 10A) on the client computer or the frequency procedures 1048 (FIG. 3) on the intermediary server are used for generating the frequency control page and for determining the frequency of advertisements displayed. As explained in relation to FIG. 8, the frequency control page or frequency GUI allows the customer to indicate how frequently he or she would like to view advertisements.

The frequency procedures then determine at 1106 whether the current saved frequency is zero, i.e., no advertisements are to be displayed during the media presentation. The saved frequency is either stored on the client computer in the user profile 1028 (FIG. 10A) or alternatively on the intermediary server in the user profile 1058 (FIG. 10B).

If the frequency is zero (step 1106—Yes), the user's bill is determined at 1112 based on a zero frequency, i.e., full charge. The bill is then displayed at 1114 to the user and the user is given at 1116 the opportunity to change the frequency of advertisements displayed during the media presentation.

If the user does not want to change the frequency, the billing data for the zero frequency is stored at 1122 and the media is presented to the user without inserting advertisements into the media presentation. If the user would like to change the frequency, the new frequency is received at 1120 and saved at 1118 either on the client computer in the user profile 1028 (FIG. 10A) or on the intermediary server in the user profile 1058 (FIG. 10B).

If the saved frequency is not zero (step 1106—No) or once the new changed frequency is saved (step 1118), either the user profile 1028 (FIG. 10A) on the client computer or alternatively the user profile 1058 (FIG. 10B) on the intermediary server is accessed at 1108. Based on the user's details, such as geographic location, age of children, content selected, content previously selected, etc., either the optimization procedures 1018 (FIG. 10A) on the client computer or alternatively the optimization procedures 1050 (FIG. 10B) on the intermediary server select at 1110 the optimal advertisements to display to the user. The system then determines at 1112 the user's bill based on the frequency of advertisements selected, i.e., the higher the selected frequency of advertisements displayed during the media presentation, the lower the cost the user is charged for viewing the media presentation. At 1114, the system then displays the bill to the user. At 1116, the user is again given the opportunity to change the frequency. If the user selects to change the frequency, the process is repeated. If the user chooses not to change the frequency, the billing data is stored at 1122.

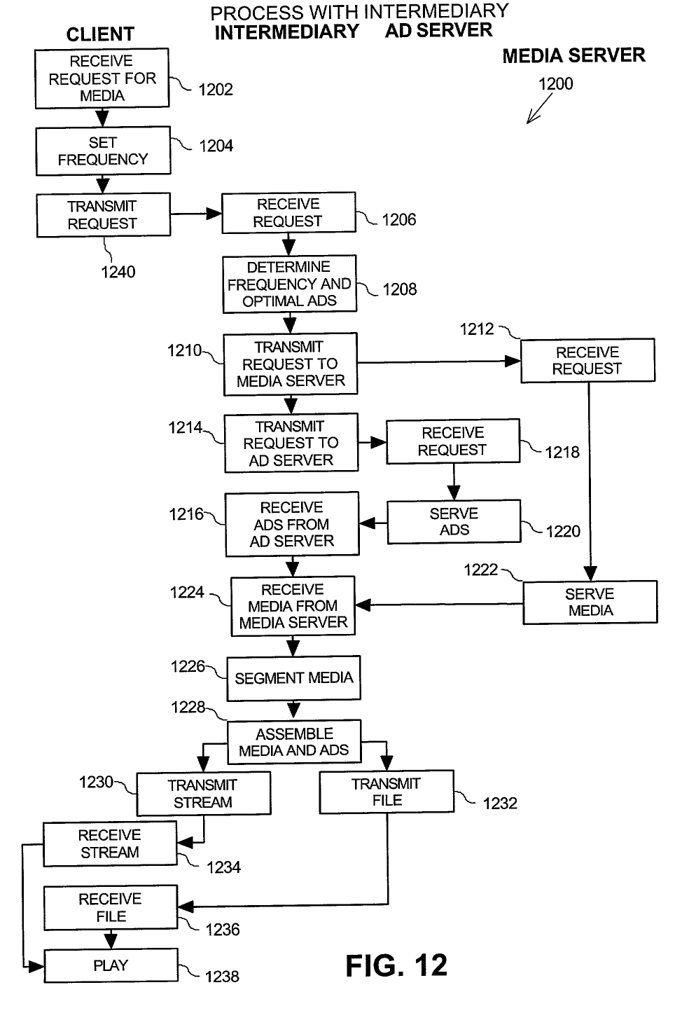

A first embodiment of the invention inserts advertisements into the broadcast at the intermediary server 908 (FIG. 9), while a second embodiment inserts the advertisements into the broadcast at the client computer 904 (FIG. 9). This is discussed in further detail in relation to FIGS. 12 and 14, and FIGS. 13 and 15 respectively.

Intermediary Server Insertion

FIG. 12 is a flow chart 1200 of a process for inserting advertisements into a media presentation at an intermediary server, according to yet another embodiment of the invention. At 1202, a user requests media, such as a movie, using the client computer 904 (FIG. 9). A frequency control page or frequency GUI, similar to that shown in FIG. 8, is then displayed to the user. Following the procedure described in relation to FIG. 11, the user then decides the frequency with which advertisements are to be displayed, and this frequency is set at 1204. A request containing the set frequency and the selected media is then transmitted at 1240 to the intermediary server.

At 1206 the intermediary server receives the request, and, using the frequency procedures 1048 (FIG. 10B) and the optimization procedures 1050 (FIG. 10B), determines at 1208 the frequency with which to display the advertisements and the optimal advertisements to display to the user. In an alternative embodiment, the client computer can determine the optimal advertisements to display to the user. The intermediary server then transmits at 1210 a request to the media server 906 (FIG. 9) for the media requested by the user.

The media server receives the request at 1212 and at 1222 serves the requested media to the intermediary server. The intermediary server then transmits a request at 1214 to the advertisement server for the optimal advertisements. The advertisement server receives the request at 1218 and at 1220 serves the requested advertisements to the intermediary server. At 1216 the intermediary server then receives the advertisements from the advertisement server, and at 1224 it receives the media from the media server.

Using the segmenting procedures 1052 (FIG. 10B) at 1226, the intermediary server then segments the media into segments or packets based on the frequency, optimal advertisements determined, and characteristics of the media, such as scene breaks, file size, content type, duration of media, or other relevant criteria. The intermediary server then uses the assembling procedures 1056 (FIG. 10B) at 1228 to assemble the media and advertisements by inserting the optimal advertisements received from the advertisements server into the media in the appropriate places, such as between scene breaks.

For downloadable media, the media and advertisements are joined into a single file using standard file joining software, such as PECK'S POWER JOIN™ software for .AVI format media and CAMEL'S MPEGJOIN™ software for .MPEG format media. The file is then transmitted at 1232 to the client computer which receives at 1236 and plays at 1238 the file on the output devices 1006 (FIG. 10A) of the client computer.

For streaming media, the media and advertisements are first converted into a single file using the above software and then converted into a streamable format using streaming software such as REALPRODUCER™ from REALNETWORKS™. Such streamable format files include video and audio files, such as WAV, MP3, REAL™, QUICKTIME™, and WINDOWS MEDIA files. Alternatively, each media segment and advertisement file can be converted to streaming format separately and broadcast to the user in the desired order. The client computer then receives the stream of media and advertisements, and at 1238 plays the stream using the output devices 1006 (FIG. 10A) of the client computer.

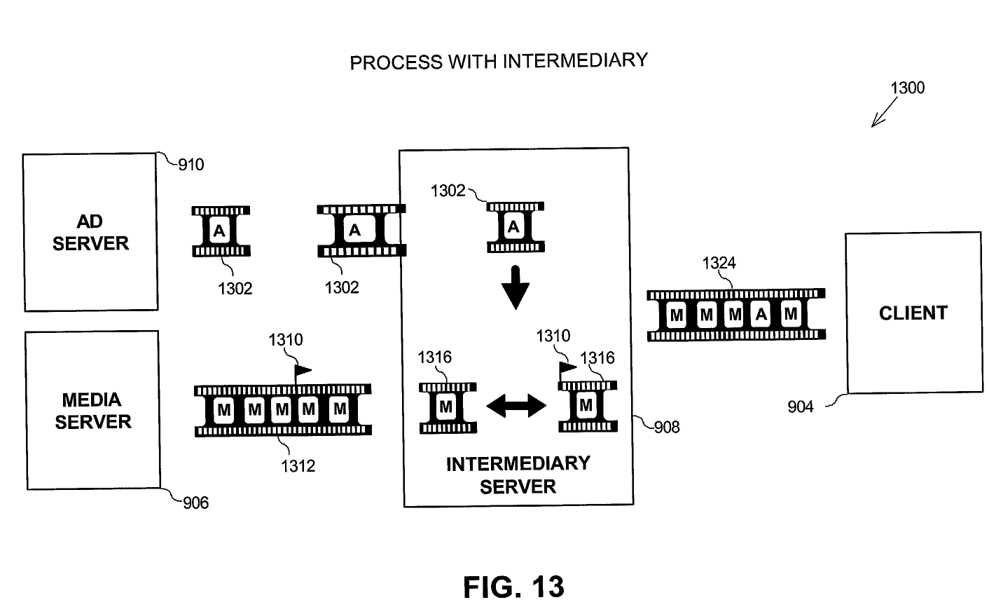

The above described process can be seen more clearly in FIG. 13, which is a diagrammatic view 1300 of a process for inserting advertisements into media at an intermediary server according to the embodiment of the invention shown in FIG. 12. The advertisement server 910 supplies advertisements 1302 to the intermediary server 908. The media server 906 supplies the media 1312 requested by the user to the intermediary server 908. The media 1312 may include flags or markings 1310 indicating the appropriate place, such as a scene break, to insert an advertisement 1302. The media 1312 is then segmented at the flags or markings 1310 into segments 1316. Optimal advertisements 1302 are then inserted between the media segments 1316. The media segments 1316 and optimal advertisements 1302 are then assembled into a single file or stream 1324 that is transmitted to the client 904.

Client Computer Insertion

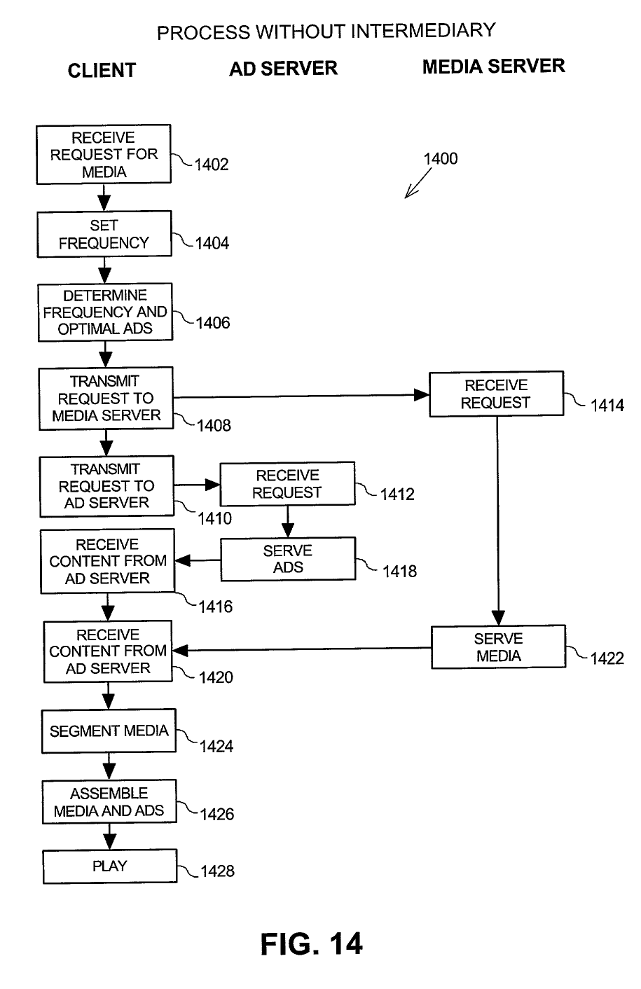

FIG. 14 is a flow chart 1400 of a process for inserting advertisements into media at a client computer according to one other embodiment of the invention. At 1402 a user requests media, such as a movie, using the client computer 904 (FIG. 9). A frequency control page or frequency GUI, similar to that shown in FIG. 8, is then displayed to the user. Following the procedure described in relation to FIG. 11, the user then decides the frequency with which advertisements are to be displayed, and the system sets this frequency (step 1404).

Using the frequency procedures 1016 (FIG. 10A) and the optimization procedures 1018 (FIG. 10A), the client computer then determines at 1406 the frequency with which to display the advertisements and the optimal advertisements to the user. The client computer, using communication procedures 1014 (FIG. 10A), then transmits at 1408 a request to the media server 906 (FIG. 9) for the media requested by the user. The media server receives the request at 1414 and at 1422 serves the requested media to the client computer. The client computer then transmits a request at 1410 to the advertisement server for the optimal advertisements. The advertisement server receives the request at 1412 and at 1418 serves the requested advertisements to the client computer. At 1416 the client computer then receives the advertisements, preferably a file or stream, from the advertisement server and at 1420 it receives the media from the media server.

Using the segmenting procedures 1020 (FIG. 10A) at 1424, the client computer then segments the media into segments or packets based on the frequency, optimal advertisements, and characteristics of the media, such as scene breaks, file size, content type, duration of media, or other relevant criteria. The client computer then uses the assembling procedures 1022 (FIG. 10A) at 1426 to assemble the media and advertisements by inserting the optimal advertisements received from the advertisements server into the media in the appropriate places, such as between scene breaks.

For downloadable media, the media and advertisements are joined into a single file using standard file joining software, such as PECK'S POWER JOIN™ software for .AVI format media or CAMEL'S MPEGJOIN™ software for .MPEG format media. For streaming media, the advertisement file is converted to streaming format, if necessary, and then broadcast between received media streams to the user. At 1428 the client computer then plays the stream or the file on the output devices 1006 (FIG. 10A) of the client computer. In the case of multicasting, a portion of the content may need to be cached while the advertisement is displayed and then displayed after the advertisement is displayed. For unicast, the media server may be instructed to delay the transmission while advertisements are displayed.

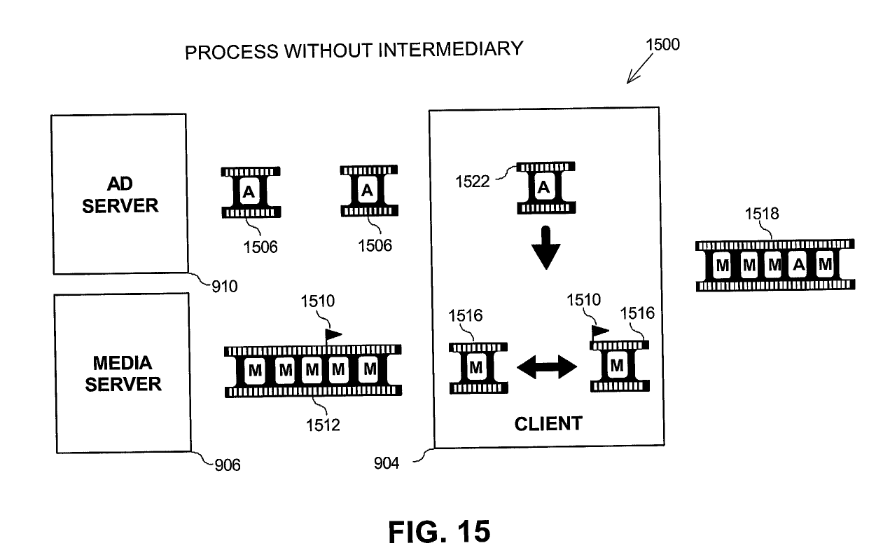

The above described process can be seen more clearly in FIG. 15, which is a diagrammatic view 1500 of a process for inserting advertisements into media at an intermediary server according to the embodiment of the invention shown in FIG. 14. The advertisement server 910 supplies advertisements 1506 to the intermediary server 908. The media server 906 supplies the media 1512 requested by the user to the intermediary server 908. The media 1512 may include flags or markings 1510 indicating the appropriate place, such as a scene break, to insert an advertisement 1506.

Using segmenting procedures 1020 (FIG. 1A), the media 1512 is segmented at the flags or markings 1510 into segments 1516. Optimal advertisements 1522 are then inserted between the media segments. Using assembling procedures 1022 (FIG. 10A), the media segments 1516 and optimal advertisements 1522 are assembled into a single file or stream 1518 that is played on the client computer by display procedures 1024 (FIG. 10A).

The system uses various characteristics of the media to determine where to place the flags or markings in the media., such as file size, the optimal place to segment the file, or the like. For example, a file that is to be delivered through streaming media, and that is 1,000K in size may be partitioned into 10 segments or packets, each of which contains 100K of data. These segments or packets may be arranged within the user profile databases 1026 (FIG. 10A) or 1056 (FIG 10B) in a sequential order. This arrangement of files comprises a queue from which information is transferred in a particular predetermined order from either the intermediary server to the client computer, or within the client computer. This order may, for example, take the form:

| Package Number | Packet Size |
|---|---|
| #1 | 100K |
| #2 | 100K |
| #3 | 100K |
| #4 | 100K |
| #5 | 100K |
| #6 | 100K |
| #7 | 100K |
| #8 | 100K |
| #9 | 100K |
| #10 | 100K |

There may also be additional information associated with these segments or packets. This additional information preferably contains data specifying the segments or packets between which advertisements may be inserted. This data may contain individual instructions paired with each distinct packet or segment, a general formula or instruction set for the entire set of segments or packets, such as “Insert an optimal advertisement every 3 packets,” or other similar structure. In the most likely instance, the instructions will correspond with each individual segment or packet of data from the original file. For example:

| Package Number | Packet Size | Insert Ad Okay? |
|---|---|---|
| #1 | 100K | False |
| #2 | 100K | False |
| #3 | 100K | False |
| #4 | 100K | True |
| #5 | 100K | False |
| #6 | 100K | True |
| #7 | 100K | False |
| #8 | 100K | False |
| #9 | 100K | True |
| #10 | 100K | False |

Advertisements of the same or different file type as the original file may be inserted into the queue as distinct files or as data packets of the same or different data type as those of the original file. For example:

| | | | | File |
|---|---|---|---|---|
| Package Number | Packet Size | Insert Ad Okay? | Ad Number | Size |
| #1 | 100K | False | | |
| #2 | 100K | False | | |
| #3 | 100K | False | | |
| #4 | 100K | True | | |
| #43 | 55K | | | |
| #5 | 100K | False | | |
| #6 | 100K | True | | |
| #202 | 60K | | | |
| #7 | 100K | False | | |
| #8 | 100K | False | | |
| #9 | 100K | True | | |
| #67 | 40K | | | |
| #10 | 100K | False | | |

Note the “true/false” statements in this example need not be binary, but instead may contain an ordinal ranking indicating the preferred slots for the insertion of advertisements. For example:

| | | | | File |
|---|---|---|---|---|
| Package Number | Packet Size | Insert Ad Okay? | Ad Number | Size |
| #1 | 100K | 0 | | |
| #2 | 100K | 0 | | |
| #3 | 100K | 0 | | |
| #4 | 100K | 1 | | |
| #43 | 55K | | | |
| #5 | 100K | 0 | | |
| #6 | 100K | 2 | | |
| #202 | 60K | | | |
| #7 | 100K | 0 | | |
| #8 | 100K | 0 | | |
| #9 | 100K | 3 | | |
| #10 | 100K | 0 | | |

In this example, the selected advertisement frequency caused the system to insert only two advertisements. No ads were inserted into the space between packet #9 and packet #10, because it was the third most favored advertisement insertion point, and only two advertisements were to be inserted. It should be noted that in order to accommodate some selected advertisement frequencies, several ads may be inserted between two media segments or packets.

Moreover, in the case of streaming media, the media server responds to requests for streaming media with data indicating how many streams to expect and providing details regarding those streams (such as the media type and codec (coder/decoder) associated with each stream). In the case of multicast streams, once the client computer or the intermediary server has requested the stream, the media server responds by sending a file describing how to join the multicast streams. The intermediary server can either re-multicast the media to client computers with the same selected advertisement frequency, thereby, multicasting the same advertisements, or unicasting advertisements directly to individual client computers.

In an alternative embodiment, at least part of the media and advertisements are stored on either the intermediary server or the client computer in the user profiles (1058 or 1032 respectively) and in the advertisement database (1060 or 1032 respectively).

As briefly mentioned above in the description relating to FIGS. 3, 6, and 7, the system periodically determines 310 and 612 whether a distinct URL (Uniform Resource Locator) or a non-distinct URL has been requested so as to determine the appropriate place to insert an advertisement. For example, two URLs are distinct if one URL is not merely the address of another Web-page within the same Web-site identified by the other URL.

Similarly, content identified by two URLs is distinct if the content identified by one URL is not embedded within the content identified by the other URL. More generally, the test whether a URL is distinct, or whether content is distinct, is made to determine the appropriate place to insert any type of supplemental content other than the content requested by the user. Such supplemental content typically is an advertisement but can include any content other than the content requested by the user. By determining if URLs are distinct and inserting supplemental content only between the content identified by distinct URLs, a stable and predictable display of the requested content is ensured.

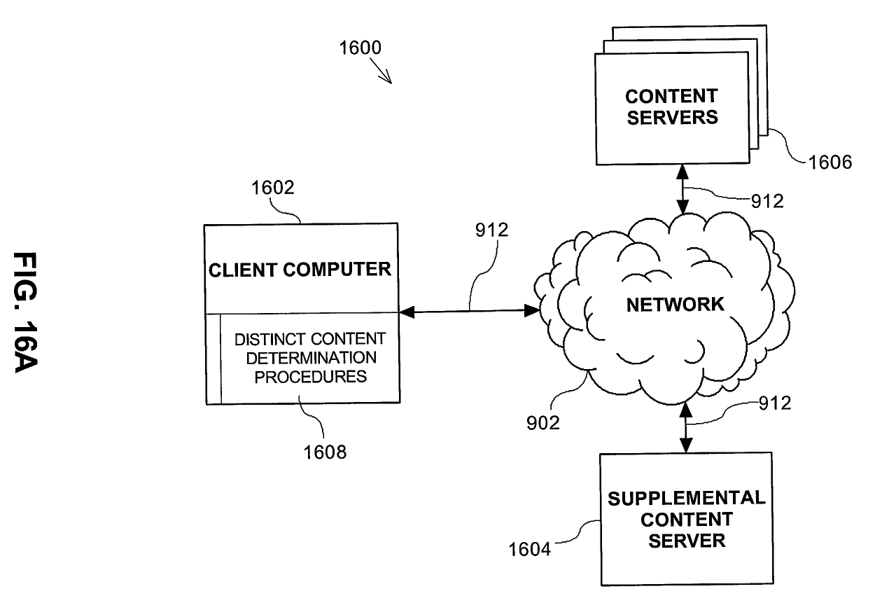

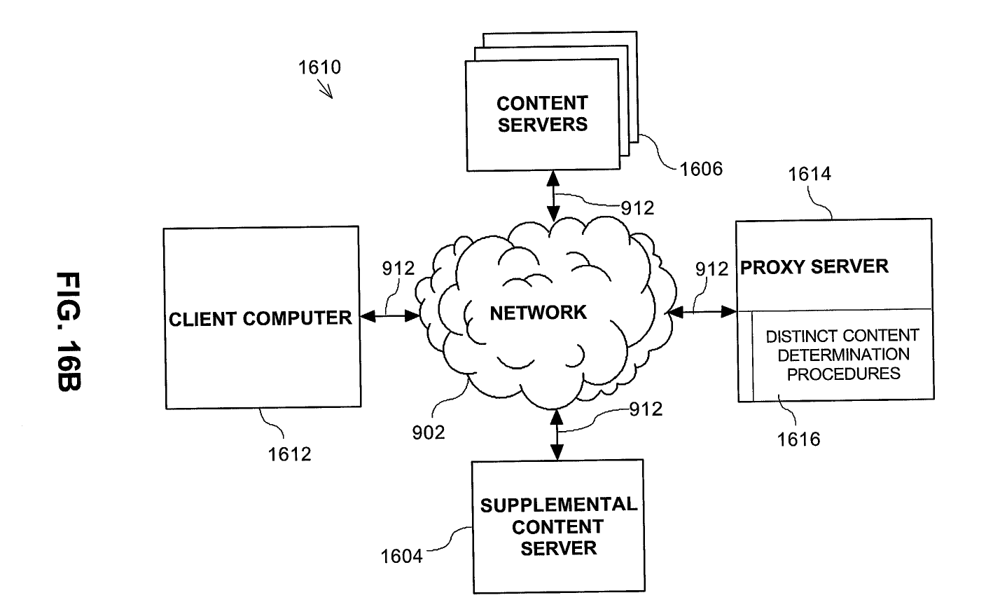

FIG. 16A is a diagrammatic view of a system 1600 for determining when to insert supplemental content between requested content according to an embodiment of the invention. A user, using a client computer 1602, connects to an electronic network 902, via a communication link 912, in a similar manner to that described above in relation to FIG. 9. Content servers 606, are also coupled to the electronic network 902, via a communication link 912. The content servers 606 store and serve requested content, such as Web-pages or media, to the client computer 1602. A supplemental content server 1604 also couples to the electronic network 902, via a communication link 912. The supplemental content server 1604 stores and serves supplemental content, such as advertisements, to the client computer 1602.

The client computer 1602 is preferably a desktop computer, but alternatively may be a set-top box, such as a cable-box, a pay-per-view box, a Web-TV® enabled television, a pay-per-view enabled Satellite-TV system, a next generation television, or any device capable of displaying content. The client computer 1602 may also be a handheld computer, personal digital assistant (PDA), cellular phone with Internet service, such as WAP (Wireless Application Protocol) or i-Mode, or the like. The client computer 1602 includes components similar to those described above in relation to FIG. 10A.

The client computer 1602, requests content from the content servers 606 to display to the user. In a preferred embodiment, users typically request and view content through a Web browser (not shown). A Web browser (hereafter “browser”) is typically a program used to view data on the World Wide Web (WWW). A browser works by requesting information, typically identified by URLs. The browser requests URLs based on data inputs initiated by the user. A user can initiate a URL request in several ways, including clicking on a hypertext link, typing a URL into an address form, voice initiation, or any other interactions between the user and the client computer. The browser processes the request made by the user and retrieves the requested content identified by the URL. For example, a user may request the Web-page http://yahoo.com/index.html. The request is sent from the Web-page to the server where the yahoo.com Web-site is hosted. The server processes the request and sends the requested Web-page back to the browser. The browser then parses the Web-page, i.e., the browser reads the file and determines whether any other requests need to be made in order to render the Web-page properly. Typically, Web-pages include references to other files such as images and audio or video files. For example, the Web-page http://psmglobal.com/index.html may contain references to the following files: http://psmglobal.com/logo.gif; http://psmglobal.com/theme_song.wav; and http://psmglobal.com/movie.ram. In order to properly render the Web-page http://psmglobal.com/index.html, the browser will request logo.gif, theme_song.wav, and movie.ram from the server where the Web-site psmglobal.com is hosted. As the browser parses the Web-page, the Web-page is rendered in a viewing area of the browser. Each component (image, audio file, etc.) is loaded into the Web-page as it is rendered in the viewing area.

Such references from one Web-page to other files are common. Often, an HTML (HyperText Markup Language) Web-page will display another or several other HTML pages within it. Typically, this is done using framesets. Newer browsers also support HTML tags such as iframe and layer. These HTML tags allow the content of two or more distinct Web-pages that are referenced by two or more different URLs to be displayed through one Web-page. Advertisers commonly use these layers, frames, and iframe tags to embed banner advertisements into Web-pages. For example, advertisers will place an image within an advertising HTML Web-page and then place the advertising HTML Web-page within a Web-site's HTML Web-page. Thus, loading the Web-site's HTML Web-page also loads the advertising HTML Web-page. As a result, when a browser requests the URL for the Web-site's HTML Web-page, it must also request the URL for the advertising HTML Web-page.

Often, Web-site based banner advertising is managed from a separate advertising server controlled by an advertising company. As a result, the domain of the URL for the advertising HTML Web-page may reference a different server from the server referenced by the domain of the URL for the Web-site HTML Web-page. For example http://Web-site.com/index.html may contain an embedded HTML Web-page that references http://adserver.com/ad_number_five.html. In this case, if a user requested http://Web-site.com, the browser would request both http://Web-site.com/index.html and http://adserver.com/ad_number_five.html.

In addition, Web-sites often employ rotating banner advertisements in which JAVASCRIPT is used to reload an HTML Web-page within a frameset or layer after a certain period of time so that a different banner advertisement is displayed to the user after the user has spent some period of time viewing a particular Web-page. In this case, the Web-page merely reloads itself. However, looking at the network content requests, it appears as though a new Web-site is being requested.

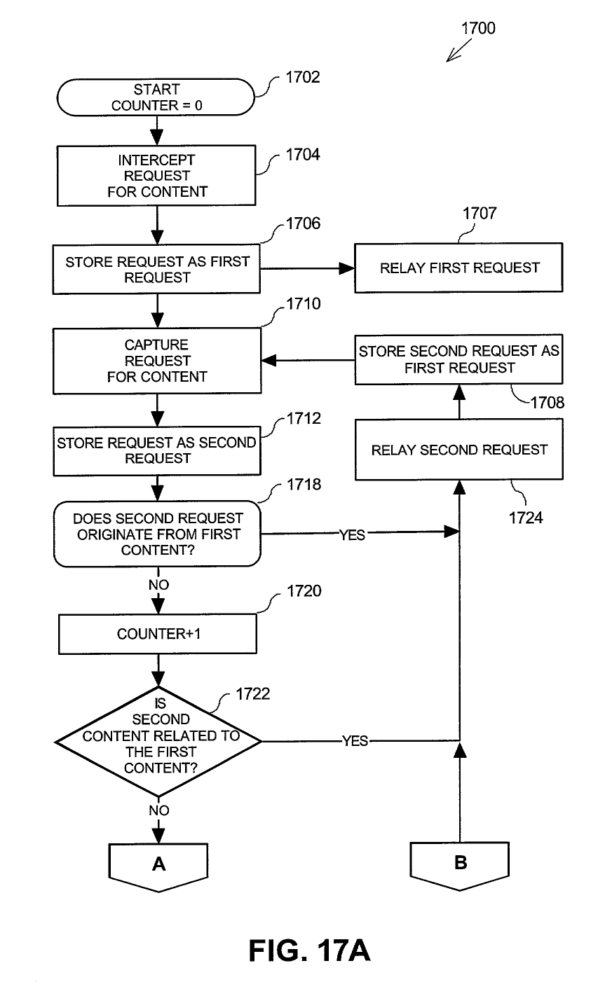

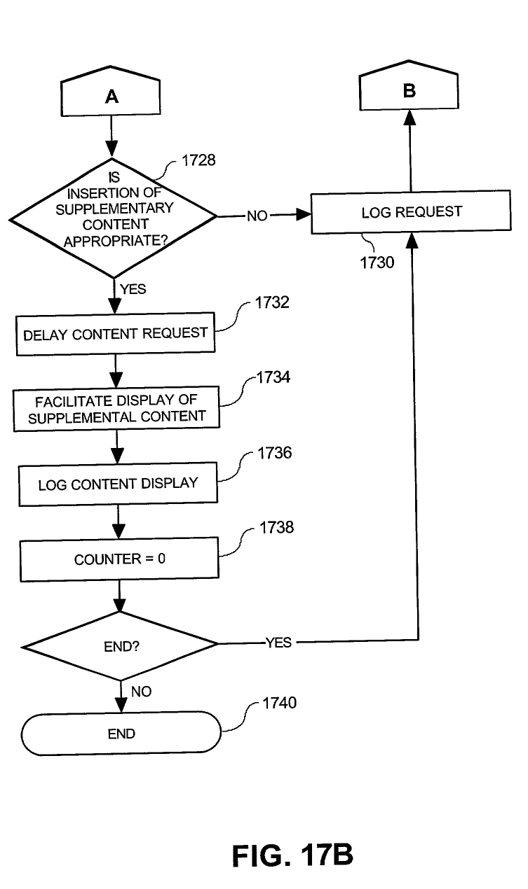

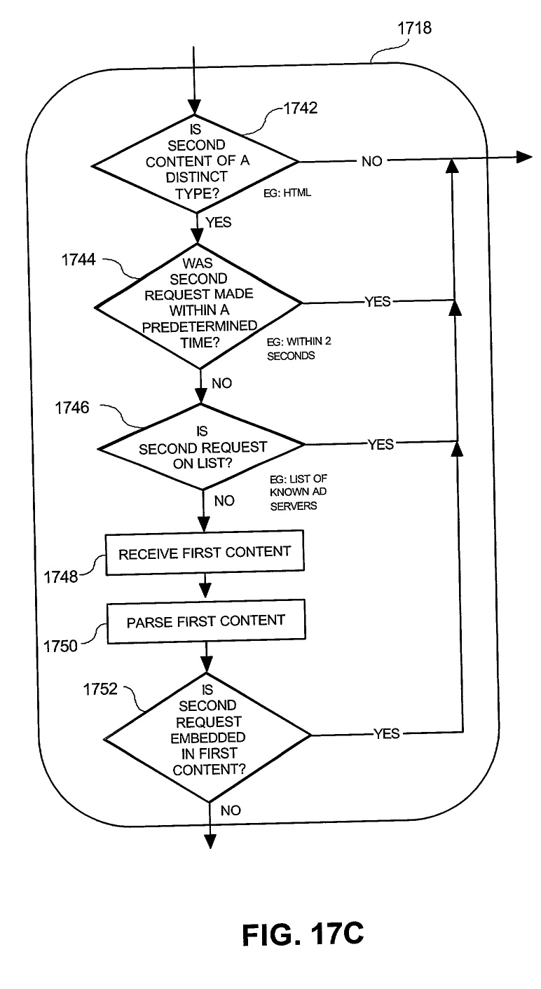

In light of the above it is imperative to determine whether the requested content is for distinct content. In the embodiment shown in FIG. 16A, the client computer 1602 also includes distinct content determination procedures 1608 described in relation to FIGS. 17A and 17B that are used to determine when requested content is distinct content.

FIG. 16B is a diagrammatic view of another system 1610 for determining where to insert supplemental content between requested content. This system 1610 is identical to the system 1600 described above in relation to FIG. 16A, except for the location of the distinct content determination procedures 1616, which in this embodiment are stored on a proxy server 1614 instead of on the client computer. The proxy server 1614 is also coupled to the network 902 by means of a communication link 912. The network 902 and the communication links 912 described above are the same as those described above in relation to FIG. 9. Use of systems 1600 (FIG. 16A) and 1610 (FIG. 16B), is described below.

FIG. 17A is a flow chart of a method 1700 for determining where to insert supplemental content between requested content using the systems of FIGS. 16A and 16B. In a preferred embodiment, this method is employed where a user is viewing sequential requested content, such as when navigating the World Wide Web (WWW). When the user, through the client computer makes a request for distinct content, the system may, if appropriate, display supplemental content to the user before the distinct content is displayed.

The method 1700 is performed by the distinct content determination procedures 1608 (FIG. 16A) on the client computer 1602 (FIG. 16A) or by the distinct content determination procedures 1616 (FIG. 16B) on the proxy server 1614 (FIG. 16A). In the embodiment where the distinct content determination procedures 1608 (FIG. 16A) are on the client computer 1602 (FIG. 16A), these procedures intercept any request for content before or at the same time as it is transmitted to the content server 1606 (FIGS. 16A and 16B). In the embodiment where the distinct content determination procedures 1616 (FIG. 16B) are on the proxy server 1614 (FIG. 16A), any request for content originating from the client computer 1612 (FIG. 16B) is first sent to the proxy server 1614 (FIG. 16B) before being relayed to the content server 1606 (FIG. 16B).

Returning to FIG. 17A, the method is started at 1702, and a counter is set to zero. The counter represents a count of the distinct content displayed since the last supplemental content was displayed. A request for content from the client computer is then intercepted at 1704 by the distinct content determination procedures 1608 (FIG. 16A) or 1616 (FIG. 16B), as described above. The request for content is stored at 1706 as a “first request.” The content that is requested by the first request will be referred to as the “first content.” The first request is then relayed at 1707 to the content servers 606 (FIGS. 16A and 16B), and content is returned to the client computer in the usual manner.

Another request for content from the client computer is subsequently captured at 1710, and the request for content stored at 1712 as a “second request.” The content that is requested by the second request will be referred to as the “second content.” At 1718 the distinct content determination procedures 1608 (FIG. 16A) or 1616 (FIG. 16B) determine whether the second request originated from the first content, i.e., the second request was embedded in the first content, or whether the second request is independent of the first content. For example, the system determines whether the user has requested a new Web-page, or whether the previously requested Web-page is merely requesting further Web-pages, such as banner advertisements, to render itself. Further details explaining how this is accomplished are set out below in relation to FIG. 17C.

If it is determined that the second request originated from the first content (1718—Yes), i.e., is not independent of the first content, then the second request is relayed at 1724 to the content servers 606 (FIGS. 16A and 16B). For example, if it is determined that the second request is for a banner advertisement, the request for the banner advertisement is relayed to the content servers as usual. The second request is then stored at 1708 as the “first request”, and the next request for requested content captured at 1710. If it is determined that the second request did not originate from the first content (1718—No), i.e., is independent of the first content, then the counter is incremented at 1720, indicating that distinct content, such as a new Web-page, was requested.

The distinct content determination procedures 1608 (FIG. 16A) or 1616 (FIG. 16B) then determine at 1722 whether the second content is related to the first content. In a preferred embodiment, this is done by determining whether the second request for content is addressed to the same content server as the first request for content. For example, it is determined if the second request is for a Web-page that is located on the same server as the previously requested Web-page. This is preferably accomplished by analyzing the Top Level Domains (TLDs) of the Uniform Resource Locators (URLs) for each request, i.e., the URLs of the first and second content are analyzed to determine if the user has navigated from one Web-site on a first server to another Web-site on a second server. For example, if a user requests www.paperstreetmedia.com/homepage.html, then requests www.paperstreetmedia.com/subpagel.html, and subsequently requests www.netadltd.com/subpagel.html, procedures 1606 or 1616 detect that the user's last request was for a Web-page from a distinct Web-site located on a distinct content server, as is evident from the domain name of the requested URL having changed from www.paperstreetmedia.com to www.netadltd.com.

If the second request is related to the first content (1722—Yes), then the second request is relayed at 1724 to the content servers. If, however, the second request is not related to the first content (1722—No), then it is determined at 1728 (FIG. 17B) whether insertion of the supplementary content is appropriate at that time. For example, if the user navigates to a new distinct Web-site, it is then determined whether an advertisement should be inserted before a Web-page from the new Web-site is displayed.

FIG. 17B is a continuation of the flow chart shown in FIG. 17A. In a preferred embodiment of the invention, procedures 1608 or 1616 use two criteria to determine whether it is an appropriate time to display the supplemental content. First, the supplemental content is displayed to the user after a certain amount of distinct content has been displayed, as determined when the value of the counter is greater than or equal to a predetermined number. For example, after the user has viewed ten distinct Web-pages, an advertisement is displayed before the next requested Web-page on a different Web-site is displayed. In an alternative embodiment, the counter may be replaced with a time function, where supplemental content is displayed after a predetermined time, for example, five minutes, has passed since the previous display of supplemental content.

The second criteria used to determine whether it is appropriate to display supplemental content involves the use of a Special Instructions List (hereafter “SIL”). The SIL is a list of specific content requests, specific content servers, or both. When the distinct content determination procedures 1608 (FIG. 16A) or 1616 (FIG. 16B) determine that a request for content and/or the content server where the requested content is located are listed on the SIL, supplemental content is displayed. For example, if a request is made for the Web-page located at www.paperstretmedia.com/index.htm, and www.paperstretmedia.com is on the SIL, then an advertisement will be displayed. This allows the supplemental content to be directly targeted at a user, as the system displays supplemental content directly related to the requested content. In an alternative embodiment, the determination of whether supplemental content should be displayed when requested content is listed on the SIL is a function of the counter and/or time.

In embodiments where larger content players that require significant load time are used to display the supplemental content, such as REALNETWORK Inc.'s REAL PLAYER, the distinct content determination procedures 1608 (FIG. 16A) or 1616 (FIG. 16B) may determine when it will be appropriate to display supplemental content in the next interstitial space and load the content player ahead of time. When this happens, the supplemental content will automatically be displayed in the next interstitial space.

If it is determined that it is inappropriate to display supplemental content (1728—No), then the second request is logged at 1730, and the second request relayed at 1724 (FIG. 17A) to the content servers. This log can contain the name, time, and date of the request. If it is determined that it is appropriate to display supplemental content (1728—Yes), then the second request is optionally delayed at 1732 from being relayed to the content servers, either as it is leaving the client computer or before the second content is displayed so that the integrity of the supplemental content is maintained. This is undertaken either by the distinct content determination procedures, or by a separate application designed for this purpose. The relay of the second request is delayed at 1732 if the supplemental content includes multimedia files that when played may be interfered with, interrupted by, or intruded upon by the display of the second content. In addition, the request may be delayed to give users the appearance that the content has been seamlessly integrated with the supplemental content. The final reason for delaying the second request involves the lag time needed to launch a content player, which as discussed above, can be addressed by launching the content player one interstitial space earlier.

The distinct content determination procedures 1608 (FIG. 16A) or 1616 (FIG. 16B) then facilitate the display at 1734 of supplemental content, i.e., they instruct the client computer to display the supplemental content. In the preferred embodiment the supplemental content is advertisements, particularity fall screen interstitial advertisements. Preferably, no other content aside from the supplemental content is displayed to the user while the supplemental content is being displayed. The supplemental content is displayed such that it cannot be shut-off or the display of the supplemental content closed before it has been displayed. Furthermore, the supplemental content is preferably displayed for a set amount of time. For example, on personal computers running the WINDOWS operating system, there are certain “hot-keys” such as control+alt+delete and alt+F4 which, when pressed can bring up a task menu, or kill the most recently running process. On a personal computer running the WINDOWS operating system, the following exemplary JAVA code may be used to defeat the operation of such “hot-keys” and ensure that the program cannot be closed: <Call SystemParametersInfo(SPI_SCREENSAVERRUNNING, True, “1”, 0)>

### Moreover, JAVA code, such as, <Call

SystemParameterslnfo(SPI_SCREENSAVERRUNNING, False, “1”,0)>can be used to ensure that full use of the keyboard and “hot-keys” is enabled after the supplemental content is displayed.

During the display of supplemental content, the only commands that are processed by the computer system are those commands that directly interact with the supplemental content. For example, if the supplemental content prompts the user to type an email address into a form field, that information will be processed. Furthermore, supplemental content can take the form of other interactive objects such as games and Virtual Reality demonstrations. In such cases, the user will be able to interact with the supplemental content and the computer system will recognize the interaction as such. Supplemental content may also exhibit “click-through” behavior where a user clicks on a Web-link within the advertisement. In this instance, depending on the parameters set within the supplemental content, the Web link may open a browser window on top of the supplemental content, or the supplemental content may close and then display the browser window with the click-through content. Furthermore, this system will most likely be used in conjunction with a system that selects the optimal advertisement as described earlier in this document.

The supplemental content displayed is then logged at 1736. This log includes the time, data and name of the supplemental content. The counter is reset to zero indicating that no distinct content has been viewed since the last display of supplemental content. The process is then repeated until it is stopped at 1740 by the user shutting down the client computer or the display application, such as the browser.

FIG. 17C is a more detailed flow chart of the determining step 1718 shown in FIG. 17A. This flow chart shows a method by which the distinct content determination procedures 1608 (FIG. 16A) or 1616 (FIG. 16B) determine whether the second request is for distinct content, or whether the second request is merely embedded within the first content, i.e., the second request is not independent of the first content.

Once the captured request is stored as the second request at 1712 (FIG. 17A), procedures 1608 or 1616 determine at 1742 whether the second content is of a type associated with distinct content. For example, most Web-pages on the World Wide Web (WWW) are composed of one main page and several component parts. In most cases, the main content page is written in some variant of HyperText Markup Language (HTML) and the URL of the Web-page has a file extension, indicating what type of file it is, such as “.html”, “.htm”, “.asp”, “.jsp”, “.shtml”, “.cfml”, “.smil”, or the like. Component parts of Web-pages include objects like images, java applets, and small multimedia files. These objects typically have identifiable file extensions such as “.class”, “jpeg”, “.gif”, “.swf”, “.ram”, or the like. A file extension is located at the end of the file name and is used by the operating system and by other programs to identify characteristics of the file. For example, on a WINDOWS operating system, the file extension “.exe” denotes an executable program file, whereas the file extension “.txt” denotes an ASCII text file.

In a preferred embodiment, to determine at 1742 the type of the second content, the distinct content determination procedures 1608 (FIGS. 16A and 16B) compare the file extension of the second request to a list of known file extensions associated with distinct content. For example, certain file extensions such as “.html” and “.asp” are associated with Web-pages and, therefore, with distinct content, and other file extensions such as “.exe” and “.gif” are not. If it is determined that the second request is not of a type associated with distinct content (1742—No), then the second request is relayed, at 1724 (FIG. 17A), to the content servers. For example, if the second request is for http://www.paperstreetmedia.com/image.gif, then it is assumed that the second request is not for distinct content, as “.gif” is not associated with distinct content. The request for index.gif is then forwarded to the content servers in the usual manner.

If it is determined that the second request is of a type associated with distinct content (1742—Yes), then it is determined at 1744 whether the second request was made within a certain amount of time after the first request was made. If the second request is for content embedded within the first content, i.e., non-distinct content, then the second request is typically made within a short amount of time after the first request is made. Thus, the distinct content determination procedures 1608 (FIGS. 16A and 16B) determine whether the second request was made within a predetermined short period of time after the first request. For example, if requests for two Web-page URLs occur within close succession of one another, there is a high probability that the second request was embedded within the first Web-page. A predetermined period of time, such as five seconds, is set such that if two URLs are requested within this predetermined period of time, then the second requests will be treated as having come from the same Web-page, i.e., as non-distinct. Therefore, if it is determined that the second request was made within the predetermined time (1744—Yes) of the first request, then it is assumed that the second request is non-distinct and the second request is relayed at 1724 (FIG. 17A) to the content servers.

If it is determined that the second request was not made within a predetermined time (1744—No) of the first request, then it is determined whether the second request is located on a list of known servers, for example, a list of known advertisement servers. For example, if the server, advertisements.doubleclick.net, is on the list of known advertisement servers and if the second request is for an advertising banner URL such as http://advertisements.doubleclick.net/ad_number_{—}123.html embedded within the Web-page http://e-trade.com, then the second request is not identified as distinct content and it is relayed at 1724 (FIG. 17A0 to the content server. In addition, banner advertisements often share the same top-level domain name (TLD). These TLDs can be listed on the list of known servers so that the distinct content determination procedures 1608 (FIG. 16A) or 1616 (FIG. 16B) do not erroneously believe that they constitute a request for distinct content.

If the second request is not on the list of known servers (1746—No), then the first content is received at 1748 from the content servers, by the distinct content determination procedures 1608 (FIG. 16A) or 1616 (FIG. 16B), and parsed at 1750, to determine at 1752 whether the second request is embedded in the first content. If the second request is embedded in the first content (1752—Yes), then the second request is relayed, at 1724 (FIG. 17A), to the content servers. If, however, the second request is not embedded in the first content (1752—No), then the counter is incremented at 1720 (FIG. 17A), indicating that a new distinct content was requested.

It should be appreciated that steps 1742, 1744, 1746, and 1748-1752 of the above described process may be used alone, or in any combination to determine whether the second request is for distinct content, i.e., was not embedded within the first content.

As a result, the above described process shown in FIGS. 17A, 17B, and 17C enables the system to determine precisely when to insert supplemental content between requested content.

While the foregoing description and drawings represent the preferred embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. The presently disclosed embodiments are therefore to be considered in all respects as illustrative and not restrictive, the scope of the invention being indicated by the appended claims, and not limited to the foregoing description.

What is claimed is:

1. A computer implemented method for determining when to insert supplemental content between requested content, comprising:
intercepting a first request from a user for first content;
capturing a second request from said user for second content;
determining that said second request is independent of said first content; and
facilitating the insertion of supplemental content between said first content and said second content.

2. The method according to claim 1, further comprising the step of ascertaining, prior to said facilitating step, that said second content is not related to said first content.

3. The method according to claim 1, wherein said determining step further comprises recognizing that said second content is of a predetermined type.

4. The method according to claim 3, wherein said recognizing step further comprises identifying a file extension associated with said second request.

5. The method according to claim 3, wherein said recognizing step further comprises identifying that said second content is not of a type normally used to render said first content.

6. The method according to claim 3, wherein said recognizing step further comprises identifying that said second content is of a type selected from a group consisting of: text documents, Hypertext Markup Language, Java Server Pages, Active Server Pages, Common Gateway Interface script files, and Per1 source code files.

7. The method according to claim 1, wherein said determining step further comprises concluding that said second request originated from said first content if said second request is made within a predetermined time.

8. The method according to claim 6, wherein said concluding step further comprises concluding that said second request originated from said first content if said second request is made within five seconds of when said first request was made.

9. The method according to claim 1, wherein said determining step further comprises ascertaining that said second request is not on a list of known supplemental content servers.

10. The method according to claim 1, wherein said determining step further comprises:
receiving said first content;
parsing said first content;
determining that said second request is not embedded in said first content.

11. An apparatus for determining when to insert supplemental content between requested content, comprising:
a bus;
a central processing unit electrically coupled to said bus;
a communications interface circuit electrically coupled to said bus and capable of electrically coupling to an electronic network; and
a memory electrically coupled to said bus, said memory comprising:
instructions for intercepting a first request from a user for first content;
instructions for capturing a second request from said user for second content;
instructions for determining that said second request did not originate from said first content; and
instructions for facilitating the insertion of supplemental content between said first content and said second content.

12. A computer program product for use in conjunction with a computer system, the computer program product comprising a computer readable storage medium and a computer program mechanism embedded therein, the computer program mechanism comprising:
instructions for intercepting a first request from a user for first content;
instructions for capturing a second request from said user for second content;
instructions for determining that said second request did not originate from said first content; and
instructions for facilitating the insertion of supplemental content between said first content and said second content.
